(19) United States
(12) Patent Application Publication
(10) Pub. No.: US 2007/0129493 A1
(43) Pub. Date: Jun. 7, 2007

(54) Random propylene diene copolymer thermoplastic vulcanizate compositions

(76) Inventors: Abdelhadi Sahnoune, Houston, TX (US); Sunny Jacob, Seabrook, TX (US)

Correspondence Address: ExxonMobil Chemical Company;Law Technology, P.O. Box 2149, Baytown, TX, 77522-2149, US

(21) Appl. No.: 11/595,672

(22) Filed: Nov. 10, 2006

Related U.S. Application Data
(60) Provisional application No. 60/742,778, filed on Dec. 6, 2005.

(51) Int. Cl. C08F 8/00

(52) U.S. Cl. 525/191; 525/240

(57) ABSTRACT

Disclosed herein is a thermoplastic vulcanizate composition comprising a discontinuous phase dispersed within a continuous thermoplastic polyolefin phase, wherein the discontinuous phase comprises a random propylene diene copolymer comprising about 68 to 95 mol % propylene, about 5 to about 32 mol % of a C₂ or a C₄-C₂₀ olefin, and about 0.1 to 10 mol % of a non-conjugated diene, and having a heat of fusion from about 1 to about 70 J/g; and wherein the continuous thermoplastic polyolefin phase comprises propylene. A method of producing the thermoplastic vulcanizate, and an article comprising the thermoplastic vulcanizate are also disclosed.

### CROSS REFERENCE TO RELATED APPLICATION

This application claims the benefit of Provisional Application No. 60/742,778 filed Dec. 6, 2005, the disclosure of which is incorporated by reference.

### FIELD OF INVENTION

Thermoplastic vulcanizates are produced from a thermoplastic polypropylene continuous phase and a random propylene-diene copolymer dispersed phase having improved characteristics over thermoplastic vulcanizates known in the art.

### BACKGROUND OF THE INVENTION

Thermoplastic vulcanizates (TPV) are comprised of a thermoplastic continuous phase and a crosslinked rubbery dispersed phase and desirably have the thermoplastic processing properties of the thermoplastic phase and a substantial amount of elasticity from the rubber phase. The Shore A/D hardness of a thermoplastic vulcanizate is generally controlled by the ratio of the harder thermoplastic phase to the softer rubber phase. The elongation to break of a thermoplastic vulcanizate is controlled by many factors including compatibility of the two phases, phase sizes, and added compatibilizers.

The discontinuous phase typically comprises one or more rubber material, which can be a traditional hydrocarbon rubbers such as EPDM rubber, butyl rubber, halobutyl rubber, copolymers of p-methylstyrene and isobutylene, natural rubber, homopolymers of conjugated dienes, and copolymers of conjugated dienes or combinations thereof. Thermoplastic vulcanizates usually comprise from about 15 to about 75 parts of the thermoplastic phase and from about 25 to about 85 parts of the rubber phase based upon 100 parts total of the thermoplastic and rubber phases.

Processing oils may be included in a TPV to improve the softness (i.e., lower the Shore A hardness) of the composition. It is desirable to be able to formulate a thermoplastic vulcanizate composition to have higher elongation to break and more toughness. Toughness is defined as the area under the stress strain curve when a tensile specimen of the thermoplastic vulcanizate is elongated to break. Preferably, it is desirable to be able to produce a TPV with improved toughness while also maintaining a TPV which is softer than (i.e., has a Shore A hardness less than) the thermoplastic continuous phase.

Thermoplastic vulcanizate (“TPV”) comprises a thermoplastic resin matrix, such as polypropylene, within which are dispersed particles of a cured elastomeric material, such as an EPDM rubber. TPVs are normally produced by a process of “dynamic vulcanization”, which is a process of vulcanizing or cross-linking the elastomeric component during intimate melt mixing with the thermoplastic resin, together with plasticizers (e.g. process oils), fillers, stabilizers, and a cross-linking system, under high shear and above the melting point of the thermoplastic. The mixing is typically done in a twin-screw extruder, to create a fine dispersion of the elastomeric material within the thermoplastic resin while the elastomeric material is cured. The levels of thermoplastic resin and plasticizer (e.g. oil) can be adjusted to produce grades having different profiles of hardness, rheology and engineering properties, although in general it is difficult to produce TPVs by dynamic vulcanization in which the content of the elastomeric phase is greater than 50 wt % of the overall polymer blend. Examples of dynamic vulcanization are described in the U.S. Pat. Nos. 4,130,535 and 4,311,628.

Relevant background references of possible interest include U.S. Pat. Nos. 6,268,438 and 6,288,171, and Thermoplastic Elastomers by G. Holden et al., 2nd Edition, Hanser Publishers (1996.)

Dynamic vulcanization involves many steps, each one critical to the eventual quality of the final product. Forming the polymer blend normally involves mechanically mixing it with the thermoplastic resin along with the processing oils, curatives, and other ingredients in a suitable high shear mixing device to comminute the rubber particles and cure them to generate cured rubber particles embedded in a continuous thermoplastic resin matrix. The cured rubber particles in the finished products have an averaged particle size of 1 to 10 micron. Careful injection of processing oil helps manage the rheological characteristics of the fluid in the reactive extruder as well as product properties such as hardness. Precise control over the size and distribution of the cross-linked elastomer particles is critical, as it affects properties such as elastic recovery (as measured through compression set). While the products produced with existing technology and material compositions have many desirable properties, there are gaps in the overall properties profile. Some of these are, improved elastic recovery, softer products, higher tensile strength, easier processability, oil-free compositions, and colorless products.

### SUMMARY OF THE INVENTION

Thermoplastic vulcanizates comprise a continuous thermoplastic phase, typically a polypropylene thermoplastic phase. A discontinuous rubber type phase is dispersed within the continuous phase. In the present invention, the discontinuous phase comprises a random propylene-diene copolymer. In one aspect of the present invention, a thermoplastic vulcanizate composition comprises a discontinuous phase dispersed within a continuous thermoplastic polyolefin phase, wherein the discontinuous phase comprises a random propylene diene copolymer comprising about 68 to 95 mol % propylene, about 5 to about 32 mol % of a C₂ or a C₄-C₂₀ olefin, and about 0.1 to 10 mol % of a non-conjugated diene, and having a heat of fusion from about 1 to about 70 J/g; and wherein the continuous thermoplastic polyolefin phase comprises polypropylene (a polyolefin or blends of polyolefins or blends of polyolefins and other thermoplastic elastomers).

In yet another aspect of the present invention, a thermoplastic vulcanizate composition comprises a discontinuous phase dispersed within a continuous polypropylene phase, wherein the discontinuous phase comprises a random propylene diene copolymer comprising about 76 to 97 wt % propylene, about 8 to about 16 wt % of ethylene, and about 2 to 4 wt % of 5-ethylidene-2-norbornene, and having a heat of fusion from about 1 to about 70 J/g.

In still another aspect of the present invention, a thermoplastic vulcanizate composition comprises a discontinuous phase dispersed within a continuous polypropylene phase, wherein the discontinuous phase consists essentially of a random propylene diene copolymer comprising about 84 to 92 wt % propylene, about 8 to about 16 wt % of ethylene, and about 2 to 4 wt % of 5-ethylidene-2-norbornene, and having a heat of fusion from about 1 to about 70 J/g.

In yet another aspect of the present invention, a thermoplastic vulcanizate composition consists essentially of a discontinuous phase dispersed within a continuous polypropylene phase, wherein the discontinuous phase consists essentially of a random propylene diene copolymer comprising about 84 to 92 wt % propylene, about 8 to about 16 wt % of ethylene, and about 2 to 4 wt % of 5-ethylidene-2-norbornene, and having a heat of fusion from about 1 to about 70 J/g.

An article comprising the thermoplastic vulcanizate is also disclosed.

### BRIEF DESCRIPTION OF THE DRAWINGS

FIG. 1 shows a electron micrographs of an embodiment of the present invention comprising 2 wt % diene; and

FIG. 2 shows a electron micrographs of an embodiment of the present invention comprising 4 wt % diene.

### DETAILED DESCRIPTION

Definition of General Terms

The term “thermoplastic vulcanizate” refers to compositions that may possess the properties of a thermoset elastomer and are reprocessable in an internal mixer. Upon reaching temperatures above the softening point or melting point of the semi-crystalline polyolefin continuous phase, they can form continuous sheets and/or molded articles with what visually appears to be complete knitting or fusion of the thermoplastic vulcanizate under conventional molding or shaping conditions for thermoplastics.

For the purposes of this invention and the claims thereto when a polymer is referred to as comprising an olefin, the olefin present in the polymer is the polymerized form of the olefin. As referred to herein, the combination of a support and an activator may be described as a catalyst precursor, a pre-catalyst compound, or a catalyst compound; these terms are used interchangeably. A catalytically active material may be interchangeably referred to as a catalytic material, or a catalyst. A catalyst system is a combination of a pre-catalyst, an activator, and optionally a support. An activator may also interchangeably referred to as a cocatalyst. A reactor is any container(s) in which a chemical reaction occurs. As used herein, the new numbering scheme for the Periodic Table Groups are used as in CHEMICAL AND ENGINEERING NEWS, 63(5), 27 (1985).

As used herein, and unless otherwise specified, a copolymer comprises two or more monomers. Accordingly, a copolymer may include two, three, or more monomers in a single polymeric chain.

Further, for purposes of this invention, Me is methyl, Ph is phenyl, Et is ethyl, Pr is propyl, iPr is isopropyl, n-Pr is normal propyl, Bu is butyl, iBu is isobutyl, tBu is tertiary butyl, p-tBu is para-tertiary butyl, TMS is trimethylsilyl, and a per fluoro radical is an organic radical having one or more available hydrogen atoms substituted with fluorine atoms. For purposes of this disclosure, the term oligomer refers to compositions having 2-75 mer units and the term polymer refers to compositions having 76 or more mer units. A mer is defined as a unit of an oligomer or polymer that originally corresponded to the olefin(s) used in the oligomerization or polymerization reaction. For example, the mer of polyethylene would be ethylene. Room temperature is 25° C., unless otherwise stated.

Thermoplastic Continuous Phase

The thermoplastic continuous phase of the present invention is preferably an olefinic thermoplastic polymer, preferably a C₂-C₂₀ alpha-olefin thermoplastic polymer. In a particularly preferred embodiment, the thermoplastic continuous phase comprises a propylene thermoplastic, desirably an isotactic polypropylene with a high melting temperature. Preferred polypropylene thermoplastics have a melting temperature of at least 110° C. and random propylene copolymer which have a melting temperature below 100° C.

In an embodiment, the continuous phase may comprise semi-crystalline polypropylene comprising semi-crystalline thermoplastic polymers from the polymerization of monoolefin monomers (e.g., 2 to 10 carbon atoms) by a high pressure, low pressure, or intermediate pressure process: or by Ziegler-Natta catalysts, or by metallocene catalysts. It may have any tacticity (e.g. isotactic and syndiotactic) or be a copolymer such as impact modified polypropylene. Desirably the monoolefin monomers converted to repeat units are at least 80, 85 or 93 percent propylene. The polypropylene can be a homopolymer, a reactor copolymer polypropylene impact modified propylene, isotactic polypropylene, syndiotactic polypropylene, impact copolymer polypropylene and other prior art propylene copolymers. Desirably it has a melting temperature peak of at least 110° C. and a heat of fusion of greater than 75 J/g, more preferably greater than 80 J/g, still more preferably greater than 90 J/g.

Exemplary thermoplastic polymers include the family of polyolefin resins, polyesters (such as polyethylene terephthalate, polybutylene terephthalate), polyamides (such as nylons), polycarbonates, styrene-acrylonitrile copolymers, polystyrene, polystyrene derivatives, polyphenylene oxide, polyoxymethylene, and fluorine-containing thermoplastics. The preferred thermoplastic resins are crystallizable polyolefins that are formed by polymerizing C₂ to C₂₀ olefins such as, but not limited to, ethylene, propylene and C₄ to C₁₂ α-olefins, such as 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another α-olefin, such as 1-butene-1; pentene-1,2-methylpentene-1,3-methylbutene-1; hexene-1,3-methylpentene-1,4-methylpentene-1,3,3-dimethylbutene-1; heptene-1; hexene-1; methylhexene-1; dimethylpentene-1 trimethylbutene-1; ethylpentene-1; octene-1; methylpentene-1; dimethylhexene-1; trimethylpentene-1; ethylhexene-1; methylethylpentene-1; diethylbutene-1; propylpentane-1; decene-1; methylnonene-1; nonene-1; dimethyloctene-1; trimethylheptene-1; ethyloctene-1; methylethylbutene-1; diethylhexene-1 and dodecene-1, may also be used.

In one embodiment, the thermoplastic polymer comprises a propylene homopolymer, a copolymer of propylene, or a mixture of propylene homopolymers and copolymers. Typically, the propylene polymer is predominately crystalline, i.e., it has a melting point generally greater than 110° C., alternatively greater than 115° C., and preferably greater than 130° C. The term “crystalline,” as used herein, characterizes those polymers that possess high degrees of inter- and intra-molecular order in the solid state. Heat of fusion, a measure of crystallinity, greater than 60 J/g, alternatively at least 70 J/g, alternatively at least 80 J/g, as determined by DSC analysis, is preferred. The heat of fusion is dependent on the composition of the polypropylene. A propylene homopolymer will have a higher heat of fusion than a copolymer or blend of a homopolymer and copolymer.

Where the thermoplastic polymer matrix is polypropylene, the matrix can vary widely in composition. For example, substantially isotactic polypropylene homopolymer or propylene copolymer containing 10 weight percent or less of a comonomer can be used (i.e., at least 90% by weight propylene). Further, polypropylene segments may be part of graft or block copolymers having a sharp melting point above 110° C. and alternatively above 115° C. and alternatively above 130° C., characteristic of the stereoregular propylene sequences. The continuous phase matrix may be a combination of homopolypropylene, and/or random, and/or block copolymers as described herein. When the matrix is a random copolymer, the percentage of the copolymerized alpha-olefin in the copolymer is, in general, up to 9% by weight, alternatively 0.5% to 8% by weight, alternatively 2% to 6% by weight. The preferred alpha-olefins contain 2 or from 4 to 12 carbon atoms. One, two or more alpha-olefins can be copolymerized with propylene.

In one embodiment the continuous phase may be a polystyrene or polystyrene derivative SBC thermoplastic elastomer or thermoplastic urethane or a combination of the above thermoplastic polyolefin with these thermoplastic elastomers. Examples of polystyrene thermoplastic elastomer may include, but are not limited to, the a flexible block copolymer component, which is comprised of a block copolymer containing rigid blocks of vinyl aromatic monomers (S) and statistical, non-rigid mid- blocks of diene/vinyl aromatic monomers (B/S). These block copolymers contain at least the block structure S-B/S-S. The glass transition temperature (T_{g}) of block S is generally above 25° C. and that of the block B/S is generally below 25° C. The B/S block is composed of 75 to 30 weight percent vinyl aromatic monomer and 25 to 70 weight percent diene monomer. Particularly preferred flexible B/S blocks have a vinyl aromatic monomer content of 60 to 40 weight percent and a diene monomer content of 40 to 60 weight percent With respect to the total block copolymer component the diene content is less than 40 weight percent, preferably 35 weight percent, and the portion of the non-rigid B/S blocks amounts to at least 50 weight percent, preferably 70 weight percent. The block copolymer component has a low modulus and yield strength, with high elongation.

Suitable vinyl aromatic monomers include styrene, alkyl-substituted styrenes such as p-methylstyrene, vinyltoluene, as well as mixtures of said monomers. The preferred monomer is styrene. Suitable diene monomers include 1,3-butadiene, isoprene, piperylene, phenylbutadiene, and mixtures of said monomers. The preferred monomer is 1,3-butadiene. The conjugated diene monomer can also be fully or partially hydrogenated. This type flexible block copolymer is commercially exemplified in Styroflex® 2G66 (BASF A.G.).

The amount of the block copolymer component in the composition of the invention generally ranges from 3 to 25 weight percent, based on the total weight of the composition including the thermoplastic elastomer component, additives and the SBC component. The preferred amount of SBC ranges from 3 to 15 weight percent, with 5 to 10 weight percent being most preferred.

Thermoplastic polyurethane (TPU) includes thermoplastic elastomer copolymers including one or more polyurethane hard blocks or segments and one or more soft blocks. In one or more embodiments, these copolymers include those compositions obtained by reacting multi-functional isocyanate(s) with chain extender(s) and optionally macroglycol(s). In one or more embodiments, these reactions occur an isocyanate index of at least 95 and in other embodiments at least 98; in these or other embodiments, these reactions occur at an isocyanate index of 105 or less, and in other embodiments 102 or less.

In one or more embodiments, thermoplastic polyurethane includes a blend of different thermoplastic polyurethanes in such amounts that the blend has at least one major T_{g} of less than 60° C.

In addition to the use of the random propylene copolymers and the SBC thermoplastic elastomers, the thermoplastic phase may additionally include polymeric modifiers of that thermoplastic phase. The polymeric modifiers specifically are those known to provide benefits in overall properties. For instance, long-chain branched thermoplastic resins compatible with the principle thermoplastic phase resin, e.g., polypropylene or high density polyethylene, can increase tensile strength and extensional viscosity, as well as other properties. Long-chain branched thermoplastic resins, which may be referred to herein as LCB-plastics, can generally be described as high molecular weight, highly branched polymers.

Discontinuous Phase

Dispersed within the continuous phase is an elastomeric discontinuous phase. The TPV of the present invention comprises a discontinuous phase comprising, consisting essentially of, or consisting of one or more random propylene-diene copolymers as defined herein.

Random Propylene Diene Copolymer

The thermoplastic elastomeric vulcanizate composition (TPV) of the present invention comprises a discontinuous phase comprising a random propylene diene copolymer component dispersed within a continuous thermoplastic phase.

The random propylene diene copolymer of the present invention comprise propylene, one or more C₂ or C₄-C₂₀ alpha olefins, and a non-conjugated diene. Most preferably, the random propylene diene copolymer comprises propylene, ethylene, and 5-ethylidene-2-norbornene (ENB).

The random propylene diene copolymer of the present invention can be prepared by polymerizing propylene with one or more of a C₂ or C₄-C₂₀ alpha olefin and a non-conjugated diene, most preferably the random propylene diene copolymer comprises propylene, ethylene, and 5-ethylidene-2-norbornene (ENB).

The monomers are preferably polymerized in the presence of a chiral metallocene catalyst system (i.e., a chiral metallocene pre-catalyst in combination with an activator and optionally a scavenger). The comonomer or comonomers used in combination with propylene may be linear and/or branched. Preferred linear alpha-olefins include ethylene or C₄ to C₈ alpha-olefins, more preferably ethylene, 1-butene, 1-hexene, and 1-octene, even more preferably ethylene or 1-butene. Preferred branched alpha-olefins include 4-methyl-1-pentene, 3-methyl-1-pentene, and 3,5,5-trimethyl-1-hexene.

Preferred non-conjugated dienes include 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; vinyl norbornene (VNB); dicyclopendadiene (DCPD), and combinations thereof.

Typically, random propylene diene copolymers useful in this invention are obtained by using catalysts that allow control of polymer tacticity. Generally these catalysts are used in combination with comonomers and/or the polymerization temperature to manipulate the level of tacticity. Useful catalysts are typically those that are capable of a level of stereoregular placement, generally by suitable chirality of a single site catalyst. Such catalysts are typically a transition metal complex generally containing a transition metal from Group 3, 4, 5, 6, 7, 8, 9 or 10 of the Periodic Table; and at least one ancillary ligand that remains bonded to the transition metal during polymerization. Preferably the transition metal is used in a reduced cationic state and stabilized by a co-catalyst or activator. The ancillary ligand may be a structure capable of forming a π bond such a cyclopentadienyl type ring structure. The ancillary ligand may also be a pyridinyl or amide ligand. The transition metal is preferably of Group 4 of the Periodic Table such as titanium, hafnium or zirconium which are preferably used in polymerization in the d⁰ mono-valent cationic state and preferably have one or two ancillary ligands. For coordination polymerizations, such catalysts typically have a ligand capable of abstraction and a ligand into which the ethylene (olefinic) group can be inserted.

The manner of activation of the catalysts can vary. Alumoxane and preferably methyl alumoxane can be used suitably in an amount to provide a molar aluminum to metallocene ratio of from 1:1 to 20,000:1. Non- or weakly coordinating anion activators (NCA's) derived and/or generated in any of the ways described in EP277004, EP426637, may also be sued as activators. The non-coordinating anion can be a Group 10-14 complex wherein boron or aluminum is the charge-bearing atom shielded by ligands, which may be halogenated, and especially perfluorinated. Preferably tetra-aryl-substituted Group 10-14 non-carbon element-based anion, especially those that are have fluorine groups substituted for hydrogen atoms on the aryl groups, or on alkyl substituents on those aryl groups.

An activation step generally forms the catalytically active ion pair from neutral precursors. This reaction may involve abstraction of an anionic group such as the methyl group to form a metallocene cation, although according to some literature zwitterions may be produced. The NCA precursor may be an ion pair of a borate or aluminate in which the precursor cation is eliminated upon activation in some manner, e.g. trityl or ammonium derivatives of tetrakis pentafluorophenyl boron (See EP277004). The NCA precursor can be a neutral compound such as a borane, which is formed into a cation by the abstraction of and incorporation of the anionic group abstracted from the metallocene (See EP426638). A precursor for the non-coordinating anion may be used with a transition metal complex supplied in a reduced valency state. The precursor may undergo a reduction-oxidation reaction. In a preferred embodiment, precursor cation may be a triphenyl carbenium derivative as in EP426637.

The non-coordinating anion may be used in approximately equimolar amounts relative to the transition metal complex, such as at least 0.25, preferably 0.5, and especially 0.8 and such as no more than 4, preferably 2 and especially 1.5.

Pyridine amine complexes, such as those described in WO03/040201 are also useful to produce the random propylene diene copolymers useful herein. The catalyst may a fluxional complex, which undergoes periodic intra-molecular re-arrangement so as to provide the desired interruption of stereoregularity as in U.S. Pat. No. 6,559,262. The catalyst may be a stereorigid complex with mixed influence on propylene insertion, see Rieger EP1070087.

Preferably the catalyst is a metallocene catalyst used with an activator and optional scavenger. Typically, mono-anionic ligands of such metallocenes are displaceable by a suitable activator to permit insertion of a polymerizable monomer or macro-monomer for polymerization on the vacant coordination site of the transition metal component. Such metallocenes are described in 1) U.S. Pat. No. 6,048,950 which discloses bis(indenyl)bis(dimethylsilyl)zirconium dichloride used together with methylalumoxane; 2) WO 98/27154 which discloses a dimethylsilyl bridged bis-indenyl hafnium di-methyl used together with a non-coordinating anion activator; and 3) EP 1 070 087 which discloses a bridged biscyclopentadienyl catalyst which has elements of asymmetry between the two cyclopentadienyl ligands to give a polymer with elastic properties. Also useful are the metallocenes described in U.S. Pat. Nos. 6,448,358 and 6,265,212, U.S. Pat. Nos. 5,198,401 and 5,391,629.

Useful other catalysts are metallocenes, such as those described in U.S. Pat. No. 5,026,798, which have a single cyclopentadienyl ring, advantageously substituted and/or forming part of a polycyclic structure, and a hetero-atom, generally a nitrogen atom, but possibly also a phosphorus atom or phenoxy group connected to a group 4 transition metal, preferably titanium but possibly zirconium or hafnium. A further example is Me₅CpTiMe₃ activated with B(CF)₃ as used to produce elastomeric polypropylene with an Mn of up to 4 million. See Sassmannshausen, Bochmann, Rosch, Lilge, J. Organomet. Chem. (1997) 548, 23-28.

When using the catalysts, the total catalyst system will generally additionally comprise one or more organo-metallic compound as scavenger. Such compounds as used in this application is meant to include those compounds effective for removing polar impurities from the reaction environment and for increasing catalyst activity. Preferred scavengers include tri-ethylaluminum, tri-isobutylaluminum, and or tri-n-octyl aluminum.

Preferably the polymerization reaction is conducted by reacting monomers in the presence of a catalyst system described herein at a temperature of from 0° C. to 200° C. for a time of from 1 second to 10 hours. Preferably homogeneous conditions are used such as a continuous solution process or a bulk polymerization process, optionally with excess monomer used as diluent. Preferably the continuous process uses some form of agitation to reduce concentration differences in the reactor and maintain steady state polymerization conditions. The heat of the polymerization reaction is preferably removed by cooling of the polymerization feed and by allowing the polymerization reaction mixture to heat up to the polymerization temperature, although internal cooling systems may be used.

The catalyst and or activator and or scavenger may be delivered to the respective reactor as a solution or slurry, either separately to the reactor, activated in-line just prior to the reactor, or pre-activated and pumped as an activated solution or slurry to the reactor.

In some embodiments the polymerization may use multiple catalyst, multiple activators or both. Likewise the polymerizations may occur in one or more reactors. In a preferred embodiment, polymerizations in different reactors may be conducted in the presence of the same catalysts and or activators and or scavengers, and in other embodiments be conducted in the presence of different catalysts and or activators and or scavengers. In a preferred embodiment, dual reactors may be used in series or parallel, see U.S. Pat. No. 6,207,756, column 8 line 20 through column 14, line 21.

In a preferred embodiment, a continuous solution polymerization process may be used to produce random propylene diene copolymers comprising, for example, propylene and one or more of ethylene or octene and a non-conjugated diene.

The polymerization process preferably utilizes a metallocene catalyst, namely, 1,1′-bis(4-triethylsilylphenyl)methylene-(cyclopentadienyl)(2,7-di-tertiary-butyl-9-fluorenyl)hafnium dimethyl or dimethyl silyl bis(2-methyl-5-phenyl indenyl)ZrMe₂ with dimethylaniliniumtetrakis(pentafluorophenyl)borate as an activator. An organoaluminum compound, namely, tri-n-octylaluminum, may be added as a scavenger to the monomer feed streams prior to introduction into the polymerization process. For production of more crystalline polymers, dimethylsilylbis(indenyl)hafnium dimethyl may be used in combination with dimethylaniliniumtetrakis(pentafluorophenyl)borate.

Preferably the solution polymerization is conducted in a single, or in two, continuous stirred tank reactors connected in series with hexane used as the solvent. In addition, toluene may be added to increase the solubility of the co-catalyst. The feed is transferred to the first reactor where the exothermic polymerization reaction is conducted adiabatically at a reaction temperature from about 50° C. to about 220° C. Hydrogen gas may also be added to the reactors as a further molecular weight regulator. If desired, polymer product is then transferred to the second reactor, which is also operated adiabatically at a temperature of about 50° C. to 200° C.

Another embodiment is described in U.S. Pat. No. 6,881,800, which is incorporated by reference. Additional monomers, solvent, metallocene catalyst, and activators can be fed to the second reactor. The polymer content leaving the second reactor is preferably from 8 to 22 weight percent. A heat exchanger then heats the polymer solution to a temperature of about 220° C. The polymer solution is then brought to a Lower Critical Solution Temperature (LCST) liquid-liquid phase separator which causes the polymer solution to separate into two liquid phases—an upper polymer-lean phase and a lower polymer-rich phase. The upper lean phase contains about 70 wt % of the solvent and the lower polymer rich phase contains about 30 wt-% polymer. The polymer solution then enters a low pressure separator vessel which operates at a temperature of about 150° C. and a pressure of 4-10 bar-g (400 to 1000 Pa) and flashes the lower polymer rich phase to remove volatiles and to increase the polymer content to about 76 wt-%. A gear pump at the bottom of the flash vessel drives the polymer rich solution to a List devolatilizer. An extruder may be coupled to the end of the List devolatilizer whereby the polymer material is transferred to a gear pump which pushes the polymer material through a screen pack. Then the polymer may be cut into pellets and fed to a water bath. A spin dryer may be used to dry the polymer pellets, which preferably have a final solvent content of less than about 0.5 wt %.

As stated above, preferred random propylene diene copolymers of the present invention may be prepared by polymerizing propylene at least one C₂ or C₄-C₂₀ alpha olefin, and at least one non-conjugated diene in the presence of a metallocene catalyst with an activator and optional scavenger, most preferably ethylene and propylene along with ENB. Preferred metallocenes are those known to favor incorporation of propylene for the production of predominantly isotactic polypropylene pentads and statistically random incorporation of the alpha-olefin comonomer(s). The term “metallocene” and “metallocene catalyst precursor” are terms known in the art to mean compounds possessing. a Group 4, 5, or 6 transition metal M, with a cyclopentadienyl (Cp) ligand or ligands which may be substituted, at least one non-cyclopentadienyl-derived ligand X, and zero or one heteroatom-containing ligand Y, the ligands being coordinated to M and corresponding in number to the valence thereof. The metallocene catalyst precursors generally require activation with a suitable co-catalyst (also referred to as an activator) in order to yield an active metallocene catalyst. An active metallocene catalyst refers generally to an organometallic complex with a vacant coordination site that can coordinate, insert, and polymerize olefins.

Preferred metallocenes for use herein include bridged and unbridged biscyclopentadienyl complexes where the cyclopentadienyl groups are, independently, a substituted or unsubstituted cyclopentadienyl group, a substituted or unsubstituted indenyl group, or a substituted or unsubstituted fluorenyl group. Preferred metallocenes include those represented by the formula: TCpCpMX₂, where T is a bridging group such as a dialkyl silica group (such as dimethylsilyl) or a hydrocarbyl group (such as methyl, ethyl, or propyl), each Cp is, independently a substituted or unsubstituted cyclopentadienyl group, a substituted or unsubstituted indenyl group (preferably a 2, 4 or 2, 4, 7 substituted indenyl group), or a substituted or unsubstituted fluorenyl group, M is a group 4 metal (preferably Hf, Zr or Ti) and each X is independently a halogen or hydrocarbyl group (such as chlorine, bromine, methyl, ethyl, propyl, butyl, or phenyl).

Preferred metallocenes for use herein include cyclopentadienyl (Cp) complexes which have two Cp ring systems for ligands. The Cp ligands preferably form a “bent sandwich complex” with the metal and are preferably locked into a rigid configuration through a bridging group. Such preferred cyclopentadienyl complexes may have the general formula:
(Cp¹R¹ₘ)R³ₙ(Cp²R²ₚ)MX_{q}

Wherein Cp¹ of ligand (Cp¹R¹ₘ) and Cp² of ligand (Cp²R²ₚ) are preferably the same, R¹ and R² each are, independently, halogen, hydrocarbyl, halocarbyl, hydrocarbyl-substituted organometalloid or halocarbyl-substituted organometalloid group containing up to 20 carbon atoms;

m is preferably 1 to 5;

p is preferably 1 to 5;

preferably two R¹ and/or R² substituents on adjacent carbon atoms of the cyclopentadienyl ring associated there can be joined together to form a ring comprising from 4 to 20 carbon atoms;

R³ is a bridging group;

n is the number of atoms in the direct chain between the two ligands and is preferably 1 to 8, most preferably 1 to 3;

M is a transition metal having a valence of from 3 to 6, preferably from group 4, 5, or 6 of the periodic table of the elements and is preferably in its highest oxidation state,

each X is a non-cyclopentadienyl ligand and is, independently, a hydrocarbyl, oxyhydrocarbyl, halocarbyl, hydrocarbyl-substituted organometalloid, oxyhydrocarbyl-substituted organometalloid or halocarbyl-substituted organometalloid group containing up to 20 carbon atoms; and

q is equal to the valence of M minus 2.

Numerous examples of the biscyclopentadienyl metallocenes described above for the invention are disclosed in U.S. Pat. Nos. 5,324,800; 5,198,401; 5,278,119; 5,387,568; 5,120,867; 5,017,714; 4,871,705; 4,542,199; 4,752,597; 5,132,262; 5,391,629; 5,278,264; 5,296,434; and 5,304,614, all of which are incorporated by reference for purposes of U.S. patent practice.

Illustrative, but not limiting examples of preferred biscyclopentadienyl metallocenes of the type described in group 1 above for the invention include the racemic isomers of:

μ-(CH₃)₂Si(indenyl)₂M(Cl)₂

μ-(CH₃)₂Si(indenyl)₂M(CH₃)₂

μ-(CH₃)₂Si(tetrahydroindenyl)₂M(Cl)₂

μ-(CH₃)₂Si(tetrahydroindenyl)₂M(CH₃)₂

μ-(CH₃)₂Si(indenyl)₂M(CH₂CH₃)₂

μ-(C₆H₅)₂C(indenyl)₂M(CH₃)₂;

wherein M may include Zr, Hf, and/or Ti.

Random Propylene Diene Copolymer Properties

Preferred random propylene diene copolymers of the present invention may have an average propylene content on a molar basis of from about 68 to 95 mol %, preferably from about 70 to about 92 mol %. The balance of the random propylene diene copolymer being one or more alpha-olefins including ethylene and/or having from 4 to 8 carbon atoms as specified above, preferably ethylene, and one or more non-conjugated diene monomers.

Preferred random propylene diene copolymers of the present invention may have an average propylene content on a weight percent basis of from about 76 to 97 wt %, preferably from about 78 to about 94 wt %. The balance of the random propylene diene copolymer being one or more alpha-olefins including ethylene and/or having from 4 to 8 carbon atoms as specified above, preferably ethylene, and one or more non-conjugated diene monomers.

Preferably, the random propylene diene copolymer comprises about 5 to about 32 mol %, of a C₂ and/or a C₄-C₂₀ olefin, more preferably from about 8 to about 30 mol %, more preferably about 11 to about 28 mol %, with about 13 to about 25 mol % being still more preferred. Too much comonomer in the random propylene diene copolymer will reduce the crystallinity provided by the crystallization of stereoregular propylene derived sequences to the point where the material lacks elastic recovery; too little and the material will be too crystalline, have a high melting point and be insufficiently elastic.

More preferably, the random propylene diene copolymer comprises about 8 to about 32 mol % ethylene, more preferably from about 9 to about 28 mol % ethylene, even more preferably from about 12 to about 25 mol % ethylene, with about 15 to about 23 mol % ethylene being still more preferred.

In another embodiment, the random propylene diene copolymer preferably comprises about 3 to about 24 wt %, of a C₂ and/or a C₄-C₂₀ olefin, more preferably from about 7 to about 21 wt %, with about 9 to about 18 wt % being still more preferred.

More preferably, the random propylene diene copolymer comprises about 5 to about 24 wt %, of ethylene, more preferably from about 9 to about 21 wt %, with about 10 to about 16 wt % being still more preferred.

Preferably, the random propylene diene copolymer comprises about 0.1 to about 10 mol % of a non-conjugated diene, more preferably from about 0.5 to about 7 mol %, more preferably about 1 to about 5 mol %, with about 2 to about 4 mol % being still more preferred.

Preferably, the random propylene diene copolymer comprises about 0.1 to about 10 mol %, 5-ethylidene-2-norbornene, more preferably from about 0.5 to about 7 mol %, more preferably about 1 to about 5 mol %, with about 2 to about 4 mol % 5-ethylidene-2-norbornene being still more preferred.

Preferably, the random propylene diene copolymer comprises about 0.3 to about 24 wt %, of a non-conjugated diene, more preferably from about 1.5 to about 18 wt %, more preferably about 3 to about 4 wt %, with about 1 to about 13 wt % being still more preferred.

Preferably, the random propylene diene copolymer comprises about 0.3 to about 24 wt %, 5-ethylidene-2-norbornene, more preferably from about 1.5 to about 18 wt %, more preferably about 2 to about 11 wt %, with about 2 to about 11 wt % 5-ethylidene-2-norbornene being still more preferred.

The random propylene diene copolymer may have a weight average molecular weight (Mw) of 5,000,000 or less, a number average molecular weight (Mn) of about 3,000,000 or less, a z-average molecular weight (Mz) of about 5,000,000 or less, and a g′ index of 0.95 or greater measured at the weight average molecular weight (Mw) of the polymer using isotactic polypropylene as the baseline, all of which may be determined by size exclusion chromatography, e.g., 3D SEC, also referred to as GPC-3D as described herein.

In a preferred embodiment, the random propylene diene copolymer may have a Mw of about 5,000 to about 5,000,000 g/mole, more preferably a Mw of about 10,000 to about 1,000,000, more preferably a Mw of about 20,000 to about 500,000, more preferably a Mw of about 50,000 to about 300,000, wherein Mw is determined as described herein.

In a preferred embodiment, the random propylene diene copolymer may have a Mn of about 5,000 to about 3,000,000 g/mole, more preferably a Mn of about 10,000 to about 1,000,000, more preferably a Mn of about 30,000 to about 500,000, more preferably a Mn of about 50,000 to about 200,000, wherein Mn is determined as described herein.

In a preferred embodiment, the random propylene diene copolymer may have a Mz of about 10,000 to about 5,000,000 g/mole, more preferably a Mz of about 50,000 to about 1,000,000, more preferably a Mz of about 80,000 to about 500,000, more preferably a Mz of about 100,000 to about 300,000, wherein Mz is determined as described herein.

The molecular weight distribution index (MWD=(Mw/Mn)), sometimes referred to as a “polydispersity index” (PDI), of the random propylene diene copolymer may be about 1.5 to 40.0. In an embodiment the MWD may have an upper limit of 40, or 20, or 10, or 5, or 4.5, and a lower limit of 1.5, or 1.8, or 2.0. In a preferred embodiment, the MWD of the random propylene diene copolymer is about 1.8 to 5 and most preferably about 1.8 to 3. Techniques for determining the molecular weight (Mn and Mw) and molecular weight distribution (MWD) may be found in U.S. Pat. No. 4,540,753 (Cozewith, Ju and Verstrate) (which is incorporated by reference herein for purposes of U.S. practices) and references cited therein, in Macromolecules, 1988, volume 21, p 3360 (Verstrate et al.), which is herein incorporated by reference for purposes of U.S. practice, and references cited therein, and in accordance with the procedures disclosed in U.S. Pat. No. 6,525,157, column 5, lines 1-44, which patent is hereby incorporated by reference in its entirety.

In a preferred embodiment, the random propylene diene copolymer may have a g′ index value of 0.95 or greater, preferably at least 0.98, with at least 0.99 being more preferred, wherein g′ is measured at the Mw of the polymer using the intrinsic viscosity of isotactic polypropylene as the baseline. For use herein, the g′ index is defined as:

$${g}^{′} = \frac{{η}_{b}}{{η}_{l}}$$

where η_{b} is the intrinsic viscosity of the random propylene diene copolymer and ηₗ is the intrinsic viscosity of a linear polymer of the same viscosity-averaged molecular weight (Mᵥ) as the random propylene diene copolymer. ηₗ=KMᵥ^{α}, K and α were measured values for linear polymers and should be obtained on the same instrument as the one used for the g′ index measurement.

In a preferred embodiment, the random propylene diene copolymer may have a crystallization temperature (Tc) measured with differential scanning calorimetry (DSC) of about 200° C. or less, more preferably, 150° C. or less, with 140° C. or less being more preferred.

In a preferred embodiment, the random propylene diene copolymer may have a density of about 0.85 to about 0.92, more preferably, about 0.87 to 0.90 g/cm³, more preferably about 0.88 to about 0.89 g/cm³ at room temperature as measured per the ASTM D-1505 test method.

In a preferred embodiment, the random propylene diene copolymer may have a melt flow rate (MFR), which is inversely related to weight average molecular weight Mw, equal to or greater than 0.2 g/10 min., preferably from about 0.5 to about 200 g/10 min. and more preferably from about 1 to about 100 g/10 min., as measured according to the ASTM D-1238 test method. In an embodiment, the random propylene diene copolymer preferably has an MFR of 0.5 to 200, especially from 2 to 30, more preferably from 5 to 30, more preferably 10 to 30 or more especially 10 to about 25. The units for “MFR” are grams per 10 minutes and the test to be herein for determining MFR is set forth in any version and condition set forth in ASTM-1238 that uses 2.16 kg. at 230° C. with a 1 minute preheat on the sample to provide a steady temperature for the duration of the experiment. This data expressed as dg of sample extruded per minute is indicated as MFR. In an alternative procedure, the test is conducted in an identical fashion except at a temperature of 190° C. This data is referred to as MI@190° C. Where the MFR is so low as to defy measurement under these conditions, molecular weight may be determined using Mooney.

In a preferred embodiment, the random propylene diene copolymer may have a heat of fusion (Hf) determined according to the procedure described in ASTM E 794-85, which is greater than or equal to about 0.5 Joules per gram (J/g), and is less than or equal to about 70 J/g, preferably less than or equal to about 50 J/g, more preferably less than or equal to about 35 J/g. Also preferably a heat of fusion that is greater than or equal to about 1 J/g, preferably greater than or equal to about 5 J/g according to the procedure described in ASTM E 794-85. In another embodiment, the random propylene diene copolymer may have a heat of fusion (Hf) determined in a manner consistent with ASTM E 794-85, which is from about 0.5 to about 70 J/g, preferably from about 1 to about 70 J/g, more preferably from about 0.5 to about 35 J/g. Preferred propylene polymers and compositions may be characterized in terms of both their melting points (Tm) and heats of fusion, which properties can be influenced by the presence of comonomers or steric irregularities that hinder the formation of crystallites by the polymer chains. The heat of fusion preferably ranges from a lower limit of 1.0 J/g, or 1.5 J/g, or 3.0 J/g, or 4.0 J/g, or 6.0 J/g, or 7.0 J/g, to an upper limit of 30 J/g, or 40 J/g, or 50 J/g, or 60 J/g or 70 J/g.

In a preferred embodiment, the random propylene diene copolymer has a % crystallinity of from 0.5 to 40, preferably 1-30, more preferably 5-25 wherein % crystallinity is determined according to the DSC procedure described above. For use herein, the crystallinity of the random propylene diene copolymer can also be expressed in terms of percentage of crystallinity. As disclosed above, the thermal energy for the highest order of polypropylene is estimated at 189 J/g (i.e., 100% crystallinity is equal to 189 J/g.). In another embodiment, the random propylene diene copolymer of the present invention preferably has a crystallinity of less than 40%, preferably about 0.25% to about 25%, more preferably from about 0.5% to about 22%, and most preferably from about 0.5% to about 20%.

In addition to this level of crystallinity, the random propylene diene copolymer preferably has a single broad melting transition. However, random propylene diene copolymer may show secondary melting peaks adjacent to the principal peak, but for purposes herein, such secondary melting peaks are considered together as a single melting point, with the highest of these peaks being considered the melting point of the random propylene diene copolymer.

The random propylene diene copolymer preferably has a melting point of equal to or less than 100° C., preferably less than 90, preferably less than 80° C., more preferably less than or equal to 75° C., preferably from about 25° C. to about 80° C., preferably about 25° C. to about 75° C., more preferably about 30° C. to about 65° C. The procedure for Differential Scanning Calorimetry is described as follows. The polymer is pressed at approximately 200° C. to 230° C. and allowed to cool by hanging the pressed material in air under ambient conditions. About 6 to 10 mg of the pressed polymer sheet of is removed with a punch die. This is annealed at room temperature for at least 2 weeks. At the end of this period, the sample is placed in a Differential Scanning Calorimeter (TA Instruments Model 2920 DSC). In a nitrogen environment, the sample is first heated to 150° C. at 10° C./min and held at 150° C. for 5 min. It is then cooled to −50° C. at 20° C./min and held at −50° C. for 5 min. Finally it is heated again to 150° C. at 10° C./min. The thermal output during the first heat cycle, recorded as the area under the melting peak of the sample which is typically peaked at about 30° C. to about 175° C. and occurs between the temperatures from about 0° C. to about 200° C. is a measure of the heat of fusion expressed in Joules per gram of polymer. The melting point is recorded as the temperature of the greatest heat absorption within the range of melting of the sample.

The random propylene diene copolymer may have a Mooney viscosity ML (1+4)@125° C., as determined according to ASTM D1646, of less than 100, more preferably less than 75, even more preferably less than 60, most preferably less than 30. As used herein, the term Mooney Viscosity (ML (1+4)@125° C.), or simply “Mooney Viscosity” is to be defined and measured according to the definition and measurement procedure set forth in U.S. Pat. No. 6,686,415, which is hereby incorporated by reference in its entirety, but particularly the text found in column 6, line 59 through column 7, line 59. Alternatively, any “Mooney Viscosity” value referenced herein (including those in the claims) is deemed to encompass any Mooney Viscosity measured in accordance with any recognized, published procedure for measuring Mooney Viscosity. Mooney viscosity, ML1+4 at 125 C, according to ASTM D1646, of from 0.5 to 100, or from 5 to 40, or from 10 to 40.

Preferred random propylene diene copolymer used in embodiments of the present invention have a tacticity index (m/r), also referred to herein as a propylene tacticity index and/or a triad tacticity index, of at least 75%. The propylene tacticity index, expressed herein as “m/r”, is determined by ¹³C nuclear magnetic resonance (NMR). The propylene tacticity index m/r is calculated as defined in H. N. Cheng, Macromolecules, 17, 1950 (1984). The designation “m” or “r” describes the stereochemistry of pairs of contiguous propylene groups, “m” referring to meso and “r” to racemic. An m/r ratio of 0 to less than 1.0 generally describes a syndiotactic polymer, and an m/r ratio of 1.0 an atactic material, and an m/r ratio of greater than 1.0 an isotactic material. An isotactic material theoretically may have a ratio approaching infinity, and many by-product atactic polymers have sufficient isotactic content to result in ratios of greater than 50.

In a preferred embodiment, the preferred random propylene diene copolymer has isotactic stereoregular propylene crystallinity. The term “stereoregular” as used herein means that the predominant number, i.e. greater than 80%, of the propylene residues in the polypropylene exclusive of any other monomer such as ethylene, has the same 1,2 insertion and the stereochemical orientation of the pendant methyl groups is the same, either meso or racemic.

Preferred random propylene diene copolymer useful in this invention have a triad tacticity index of three propylene units, as measured by ¹³C NMR, of 75% or greater, 80% or greater, 82% or greater, 85% or greater, or 90% or greater. The triad tacticity index of a polymer is the relative tacticity of a sequence of three adjacent propylene units, a chain consisting of head to tail bonds, expressed as a binary combination of m and r sequences. It is usually expressed for semi-amorphous copolymers of the present invention as the ratio of the number of units of the specified tacticity to all of the propylene triads in the copolymer. The triad tacticity index (mm fraction) of a propylene copolymer can be determined from a ¹³C NMR spectrum of the propylene copolymer and the following formula:

$$m m Fraction = \frac{PPP ( m m )}{PPP ( m m ) + PPP ( mr ) + PPP ( rr )}$$

where PPP(mm), PPP(mr) and PPP(rr) denote peak areas derived from the methyl groups of the second units in the following three propylene unit chains consisting of head-to-tail bonds:

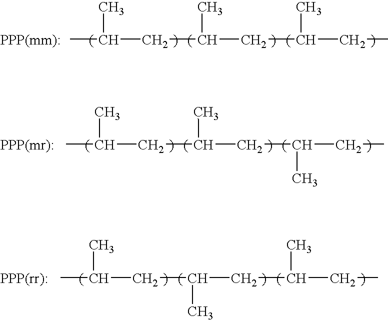

The ¹³C NMR spectrum of the propylene copolymer is measured as described in U.S. Pat. No. 5,504,172. The spectrum relating to the methyl carbon region (19-23 parts per million (ppm)) can be divided into a first region (21.2-21.9 ppm), a second region (20.3-21.0 ppm) and a third region (19.5-20.3 ppm). Each peak in the spectrum was assigned with reference to an article in the journal Polymer, Volume 30 (1989), page 1350 or “Macromolecules”, 17 (1984), 1950 which are fully incorporated by reference. (In the event of a conflict between the Polymer article and the Macromolecules article, the Polymer article shall control). In the first region, the methyl group of the second unit in the three propylene unit chain represented by PPP (mm) resonates. In the second region, the methyl group of the second unit in the three propylene unit chain represented by PPP (mr) resonates, and the methyl group (PPE-methyl group) of a propylene unit whose adjacent units are a propylene unit and an ethylene unit resonates (in the vicinity of 20.7 ppm). In the third region, the methyl group of the second unit in the three propylene unit chain represented by PPP (rr) resonates, and the methyl group (EPE-methyl group) of a propylene unit whose adjacent units are ethylene units resonates (in the vicinity of 19.8 ppm). The calculation of the triad tacticity is outlined in the techniques shown in U.S. Pat. No. 5,504,172. Subtraction of the peak areas for the error in propylene insertions (both 2,1 and 1,3) from peak areas from the total peak areas of the second region and the third region, the peak areas based on the 3 propylene units-chains (PPP(mr) and PPP(rr)) consisting of head-to-tail bonds can be obtained. Thus, the peak areas of PPP(mm), PPP(mr) and PPP(rr) can be evaluated, and hence the triad tacticity of the propylene unit chain consisting of head-to-tail bonds can be determined.

The triad tacticity can be determined from a 13C-NMR spectrum of the polymer, as described by J. A. Ewen, “Catalytic Polymerization of Olefins”, (the Ewen method); and Eds. T. Keii, K. Soga; Kodanska Elsevier Pub.; Tokyo, 1986, P 271, and as described in detail in U.S. Patent Application US2004/054086 filed Mar. 18, 2004 on page 8, in numbered paragraphs [0046] to [0054], all of which are incorporated by reference herein.

In another embodiment polymers that are useful in this invention as random propylene diene copolymers include random copolymers of propylene having a heat of fusion as determined by Differential Scanning Calorimetry (DSC) of less than 70 J/g, an MFR of 50 dg/min or less, and contain stereoregular propylene crystallinity preferably isotactic stereoregular propylene crystallinity. In another embodiment the polymer is a random copolymer of propylene and at least one comonomer selected from ethylene, C₄-C₁₂ α-olefins, and combinations thereof. Preferably the random copolymers of propylene comprises from 10 wt % to 25 wt % polymerized ethylene units and 0.1 wt % to 10 wt % non-conjugated diene units, based on the total weight of the polymer; has a narrow intermolecular composition distribution (e.g. 75% or more); has a melting point (Tm) of from 25° C. to 120° C., or from 35° C. to 80° C.; has a heat of fusion within the range having an upper limit of 70 J/g or 25 J/g and a lower limit of 1 J/g or 3 J/g; has a molecular weight distribution Mw/Mn of from 1.8 to 4.5; and has a melt flow rate of less than 40 dg/min, or less than 20 dg/min (as measured at 230° C., and 2.16 kg, ASTM D-1238).

In another embodiment, a random propylene diene copolymer can be a blend of discrete random propylene diene co-polymers. Such blends can include two or more polyethylene copolymers (as described above), two or more polypropylene copolymers (as described above), or at least one of each such polyethylene copolymer and polypropylene copolymer, so long as the blend would qualify as a random propylene diene copolymer. Each of the random propylene diene copolymers are described above and the number of random propylene diene copolymers in a preferred embodiment may be three or less, more preferably two or less.

In an embodiment of the invention, the random propylene diene copolymer may comprise a blend of two random propylene diene copolymers differing in the olefin content, the diene content, or both. Preferably, one random propylene diene copolymer may comprise about 7 to 13 mol % olefin and about 1 to 2 mol % diene, while the other random propylene diene copolymer may comprise about 14 to 22 mol % olefin, and about 2 to 4 mol % diene.

In a preferred embodiment, the random propylene diene copolymer may comprise a propylene based elastomeric polymer, produced by random polymerization processes leading to polymers having randomly distributed irregularities in stereoregular propylene propagation. This is in contrast to block copolymers in which constituent parts of the same polymer chains are separately and sequentially polymerized.

The term “elastomeric polymer” indicates that the heat of fusion of the polymer as determined by DSC is less than 75 J/g. Generally then the melting point as determined by DSC will below 105° C. This is in contrast to propylene copolymers or atactic polymers containing propylene derived units, which lack recovery from elastic deformation.

The random propylene diene copolymer is “propylene based” in the sense that the amount of propylene in the polymer is for propylene sequences to crystallize to give rise provide a detectable heat of fusion. This is in contrast with known elastomeric polymers based on ethylene and propylene in which the heat of fusion can be attributed to ethylene derived polymer sequences. Preferably the polymers contain isotactic propylene sequences, separated by stereo or regio error or by one or more units from a comonomer.

In another embodiment, the random propylene diene copolymer of the present invention may comprise copolymers prepared according the procedures in WO 02/36651 which is incorporated by reference here. Likewise, the random propylene diene copolymer may comprise polymers consistent with those described in WO 03/040202, WO 03/040095, WO 03/040201, WO 03/040233, and/or WO 03/040442. Additionally, the random propylene diene copolymer may comprise polymers consistent with those described in EP 1,233,191, and U.S. Pat. No. 6,525,157.

Thermoplastic Vulcanizates

Thermoplastic vulcanizates of the present invention comprise from about 90 to about 10 parts of the thermoplastic phase and from about 10 to about 90 parts of the discontinuous phase comprising a random propylene diene copolymer, based upon 100 parts total of the thermoplastic and the discontinuous phases.

In a preferred embodiment, the discontinuous phase is present in the thermoplastic vulcanizate at about 20 wt %, preferably at about 30 wt %, preferably at about 40 wt %, preferably at 50 wt %, preferably at 60 wt %, preferably at 70 wt %, preferably at 80 wt %, based on the total amount of discontinuous phase and continuous phase present in the composition.

In addition to the random propylene diene copolymer, the discontinuous phase of the present invention may also comprise one or more additional rubber compounds. The rubber can be EPDM rubber, butyl rubber, halobutyl rubber, or a halogenated (e.g. brominated) copolymer of p-alkylstyrene and an isomonoolefin of 4 to 7 carbon atoms. “Butyl rubber” is defined a polymer predominantly comprised of repeat units from isobutylene but including a few repeat units of a monomer which provides sites for crosslinking. The monomers which provide sites for crosslinking, can be a polyunsaturated monomer such as a conjugated diene or divinyl benzene. Desirably from about 90 to about 99.5 weight percent of the butyl rubber are repeat units derived from the polymerization of iso-butylene, and from about 0.5 to about 10 weight percent of the repeat units are front at least one polyunsaturated monomer having from 4 to 19 carbon atoms. Preferably the polyunsaturated monomer is isoprene or divinylbenzene.

The polymer may be halogenated to further enhance reactivity in crosslinking. Preferably the halogen is present in amounts from about 0.1 to about 10 weight percent, more preferably about 0.5 to about 3.0 weight percent based upon the weight of the halogenated polymer; preferably the halogen is chlorine or bromine. The brominated copolymer of p-alkylstyrene, having from about 9 to 12 carbon atoms, and an isomonoolefin, having from 4 to 7 carbon atoms, desirably has from about 88 to about 99 weight percent isomonoolefin, more desirably from about 92 to about 98 weight percent, and from about 1 to about 12 weight percent p-alkylstyrene, more desirably from about 2 to about 8 weight percent based upon the weight of the copolymer before halogenation. Desirably the alkylstyrene is p-methylstyrene and the isomonoolefin is isobutylene. Desirably the percent bromine is from about 0.2 to about 8, more desirably from about 0.2 to about 3 weight percent based on the weight of the halogenated copolymer. The copolymer is a complementary amount, i.e., from about 92 to about 99.8, more desirably from about 97 to about 99.8 weight percent. These polymers are commercially available from ExxonMobil Chemical Co.

The TPV may also comprise other rubbers including natural and synthetic rubbers as defined in ASTM D 1566. Examples of preferred rubbers include ethylene propylene rubber, neoprene rubber, styrenic block copolymer rubbers (including SI, SIS, SB, SBS, SIBS, SEBS, SEPS, and the like (S is styrene, I is isoprene, B is butadiene, EB is ethylenebutylene, EP is ethylenepropylene), butyl rubber, halobutyl rubber, copolymers of isobutylene and para-alkylstyrene, and halogenated copolymers of isobutylene and para-alkylstyrene.

Other rubber such as natural rubber or synthetic homo or copolymers preferably comprise at least one conjugated diene that can be used in the dynamic vulcanizate. These rubbers are higher in unsaturation than EPDM rubber and butyl rubber. The natural rubber and said homo or copolymers of a diene can optionally be partially hydrogenated to increase thermal and oxidative stability. The synthetic rubber can be nonpolar or polar depending on the comonomers. Desirably the homo or copolymers of a diene have at least 50 weight percent repeat units from at least one conjugated diene monomer having from 4 to 8 carbon atoms. Comonomers may be used and include vinyl aromatic monomer(s) having from 8 to 12 carbon atoms and acrylonitrile or alkyl-substituted acrylonitrile monomer(s) having from 3 to 8 carbon atoms. Other comonomers desirably used include repeat units from monomers having unsaturated carboxylic acids, unsaturated dicarboxylic acids, unsaturated anhydrides of dicarboxylic acids, and include divinylbenzene, alkylacrylates and other monomers having from 3 to 20 carbon atoms. Examples of synthetic rubbers include synthetic polyisoprene, polybutadiene rubber, styrene-butadiene rubber, butadiene-acrylonitrile rubber, etc. Amine-functionalized, carboxy-functionalized or epoxy-functionalized synthetic rubbers may be used, and examples of these include maleated EPDM, and epoxy-functionalized natural rubbers. These materials are commercially available.

In a preferred embodiment, the TPV of the present invention is essentially free of EPDM rubber. In another preferred embodiment, the TPV of the discontinuous phase of the present invention consists essentially of the random propylene diene copolymer. In yet another preferred embodiment, the TPV of the present invention consists essentially of the random propylene diene copolymer dispersed in a polypropylene continuous phase. The random propylene diene copolymer is preferably present in the discontinuous phase in amounts from about 1 wt % to 100 wt % of the total discontinuous phase. Preferably, the discontinuous phase comprises at least 5 wt %, preferably at least 10 wt %, more preferably at least 20 wt %, more preferably at least 30 wt %, more preferably at least 40 wt %, more preferably at least 50 wt %, more preferably at least 60 wt %, more preferably at least 70 wt %, more preferably at least 80 wt %, more preferably at least 90 wt %, more preferably at least 95 wt %, more preferably at least 99 wt % of the total discontinuous phase. In a preferred embodiment, the discontinuous phase consists of or consists essentially of one or more of the above disclosed random propylene diene copolymers.

Minor amounts of other polymers may be added to modify flow properties, or as additives, such as polymeric antioxidants. Non-polymeric materials such as oils, fillers, including nano-clays, diluents and additives may be also be present in the TPV of the present invention.

The TPV of the present invention may further comprise one or more additives comprising components conventional to TPV, e.g. fillers, oils, curatives, processing aids, and the like. These additives may be present in the TPV at from 0, up to about 90 wt %. More preferably, the additives may be present in the TPV at 10 to about 80 weight percent of the TPV, more desirably from about 15 to about 70 and preferably from about 25 to about 60 weight percent, based on the total weight of the TPV composition.

Accordingly, the thermoplastic vulcanizate can include a variety of additives. The additives include particulate fillers such as carbon black, silica, titanium dioxide, colored pigments, clay; zinc oxide; stearic acid; stabilizers; anti-degradants; flame retardants; processing aids; adhesives; tackifiers; plasticizers; wax; discontinuous fibers (such as world cellulose fibers) and extender oils. When extender oil is used it can be present in amounts from about 5 to about 300 parts by weight per 100 parts by weight of the blend of the continuous phase and the discontinuous phase. The amount of extender oil (e.g., hydrocarbon oils and ester plasticizers) may also be expressed as from about 30 to 250 parts, and more desirably from about 70 to 200 parts by weight per 100 parts by weight of said continuous phase and the discontinuous phase. When non-black fillers are used, it is desirable to include a coupling agent to compatibilize the interface between the non-black fillers and polymers. Desirable amounts of carbon black, when present, are from about 5 to about 250 parts by weight per 100 parts by weight of the combined continuous phase and the discontinuous phase.

Another component to the dynamic vulcanizate is the curative which crosslinks or vulcanizes the crosslinkable discontinuous phase. The type of curative used in this disclosure depends on the type of rubber to be crosslinked. The curatives for each type of rubber are conventional for those rubbers in thermoplastic vulcanizates and are used in conventional amounts. The curatives include, but are not limited to, phenolic resin curatives, sulfur curatives, with or without accelerators, accelerators alone, peroxide curatives, hydrosilation curatives using silicon hydride and platinum or peroxide catalyst, and the like. In a preferred embodiment, the curative comprises stannous chloride, zinc oxide, and a phenolic resin.

Those ordinarily skilled in the art will appreciate the appropriate quantities, types of cure systems, and vulcanization conditions required to carry out the vulcanization of the rubber. The rubber can be vulcanized by varying the amount of curative used, by varying the curing temperature, and/or by varying the time of cure in order to obtain the optimum crosslinking desired. In general, however, the amount of curative employed is such that the dispersed phase of the heterogeneous blend, following post-polymerization curing, comprises at least 0.1 wt % of a curative, such as from about 0.5% to about 5% of a curative.

Exemplary curatives include phenolic resin cure systems, peroxide cure systems, and silicon-containing cure systems. In one or more embodiments, the phenolic resins include those disclosed in U.S. Pat. Nos. 2,972,600, 3,287,440, 5,952,425 and 6,437,030, and International Application No. PCT/US04/30518, which are incorporated herein by reference for purpose of U.S. patent practice.

Phenolic resin curatives can be referred to as resole resins, and include those resins made by the condensation of alkyl substituted phenols or unsubstituted phenols with aldehydes, such as formaldehydes, in an alkaline medium or by condensation of bi-functional phenol-di-alcohols. The alkyl substituents of the alkyl substituted phenols may contain 1 to about 10 carbon atoms. Dimethyl-ol phenols or phenolic resins, substituted in para-positions with alkyl groups containing 1 to about 10 carbon atoms are preferred. In one embodiment, a blend of octyl phenol and nonylphenol-formaldehyde resins are employed. The blend may include from about 25 to about 40% by weight octyl phenol and from about 75 to about 60% by weight nonylphenol (optionally from about 30 to about 35 weight percent octyl phenol and from about 70 to about 65 weight percent nonylphenol). In one embodiment, the blend includes about 33% by weight octylphenol-formaldehyde and about 67% by weight nonylphenol formaldehyde resin, where each of the octylphenol and nonylphenol include methylol groups. This blend can be solubilized in paraffinic oil at about 30% solids.

Useful phenolic resins may be obtained under the tradenames SP-1044, SP-1045 (Schenectady International; Schenectady, N.Y.), which are referred to as alkylphenol-formaldehyde resins. SP-1045 is believed to be an octylphenol-formaldehyde resin that contains methylol groups. The SP-1044 and SP-1045 resins are believed to be essentially free of halogen substituents or residual halogen compounds. By essentially free of halogen substituents, it is meant that the synthesis of the resin provides for a non-halogenated resin that may only contain trace amounts of halogen containing compounds.

In one or more embodiments, the phenolic resin can be used in combination with a halogen source, such as stannous chloride, and a metal oxide or reducing compound such as zinc oxide. Where a phenolic resin curative is employed, a vulcanizing amount of curative preferably comprises from about 1 to about 20 parts by weight, more preferably from about 3 to about 16 parts by weight, and even more preferably from about 4 to about 12 parts by weight, phenolic resin per 100 parts by weight rubber.

Useful peroxide curatives include organic peroxides including, but are not limited to, di-tert-butyl peroxide, dicumyl peroxide, t-butylcumyl peroxide, α,α-bis(tert-butylperoxy)diisopropyl benzene, 2,5-dimethyl-2,5-di(t-butylperoxy)hexane (DBPH), 1,1-di(tert-butylperoxy)-3,3,5-trimethyl cyclohexane, n-butyl-4-4-bis(tert-butylperoxy)valerate, benzoyl peroxide, lauroyl peroxide, dilauroyl peroxide, 2,5-dimethyl-2,5-di(tert-butylperoxy)hexyne-3, and mixtures thereof. Also, diaryl peroxides, ketone peroxides, peroxydicarbonates, peroxyesters, dialkyl peroxides, hydroperoxides, peroxyketals and mixtures thereof may be used. Useful peroxides and their methods of use in dynamic vulcanization of thermoplastic vulcanizates are disclosed in U.S. Pat. No. 5,656,693.

In one or more embodiments, the peroxide curatives are employed in conjunction with a coagent. Examples of coagents include triallylcyanurate, triallyl isocyanurate, triallyl phosphate, sulfur, N-phenyl bis-maleamide, zinc diacrylate, zinc dimethacrylate, divinyl benzene, 1,2 polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, oximer for e.g., quinone dioxime. In order to maximize the efficiency of peroxide/coagent crosslinking the mixing and dynamic vulcanization are preferably carried out in a nitrogen atmosphere.

Where a peroxide curative is employed, a vulcanizing amount of curative preferably comprises from about 1×10⁻⁴ moles to about 2×10⁻² moles, more preferably from about 2×10⁻⁴ moles to about 2×10⁻³ moles, and even more preferably from about 7×10⁻⁴ moles to about 1.5×10⁻³ moles per 100 parts by weight rubber.

Useful silicon-containing cure systems include silicon hydride compounds having at least two SiH groups. It is believed that these compounds react with carbon-carbon double bonds of unsaturated polymers in the presence of a hydrosilation catalyst. Silicon hydride compounds that are useful in practicing the present invention include, but are not limited to, methylhydrogen polysiloxanes, methylhydrogen dimethyl-siloxane copolymers, alkyl methyl polysiloxanes, bis(dimethylsilyl)alkanes, bis(dimethylsilyl)benzene, and mixtures thereof.

Useful catalysts for hydrosilation include, but are not limited to, peroxide catalysts and catalysts including transition metals of Group VIII. These metals include, but are not limited to, palladium, rhodium, and platinum, as well as complexes of these metals. For a further discussion of the use of hydrosilation to cure thermoplastic vulcanizates, reference can be made to U.S. Pat. No. 5,936,028. In one or more embodiments, a silicon-containing curative can be employed to cure an elastomeric copolymer including units deriving from 5-vinyl-2-norbornene.

Where silicon-containing curative is employed, a vulcanizing amount of curative preferably comprises from 0.1 to about 10 mole equivalents, and preferably from about 0.5 to about 5 mole equivalents, of SiH per carbon-carbon double bond.

In one or more embodiments, curatives that are useful for curing rubber include those described in U.S. Pat. Nos. 5,013,793, 5,100,947, 5,021,500, 4,978,714, and 4,810,752.

The terms “blend” and “thermoplastic vulcanizate” used herein mean a mixture ranging from small particles of crosslinked random propylene diene copolymer and/or other rubber in the discontinuous phase, well dispersed in a semi-crystalline polypropylene matrix to co-continuous phases of the semi-crystalline polypropylene and a partially to fully crosslinked discontinuous phase, or combinations thereof. The term “thermoplastic vulcanizate” indicates the components of the discontinuous phase, preferably the random propylene diene copolymer, is at least partially vulcanized (crosslinked).

Subsequent to dynamic vulcanization (curing) of the discontinuous rubber phase comprising the random propylene diene copolymer (of the thermoplastic vulcanizate, desirably less than 20 or 50 weight percent of the curable rubber phase is extractable from a specimen of the thermoplastic vulcanizate in boiling xylene. Techniques for determining extractable rubber as set forth in U.S. Pat. No. 4,311,628, are herein incorporated by reference.

Dynamic vulcanization refers to a vulcanization or curing process for a rubber contained in a blend with a thermoplastic resin, wherein the rubber is crosslinked or vulcanized under conditions of high shear at a temperature above the melting point of the thermoplastic. Dynamic vulcanization can occur in the presence of a processing oil, or the oil can be added after dynamic vulcanization (i.e., post added), or both (i.e., some can be added prior to dynamic vulcanization and some can be added after dynamic vulcanization).

The TPV of the present invention preferably has a Shore D hardness of less than 70, preferably less than 60. In a preferred embodiment, the Shore A hardness, determined according to ISO 868 is preferably less than about 80. The TPV of the present invention also preferably has a Shore A hardness of less than about 80, preferably less than about 60, with less than about 50 being more preferred.

The TPV of the present invention preferably has a tensile strength at break as measured by ISO 527 at 23° C. of greater than about 0.5 MPa, preferably greater than 2 MPa, with greater than 4 MPa being more preferred.

The TPV of the present invention preferably has an ultimate elongation as measured by ISO 527 of greater than about 50%, preferably greater than 100%, with greater than 200% being more preferred.

The TPV of the present invention preferably has a tension set, determined according to ISO 2285 of preferably has a tension set of less than about 70%, preferably less than about 50, with less than about 20% being more preferred.

The TPV of the present invention preferably has a LCR viscosity, Pa·s@1200 l/s of less than about 200 Pa·s@1200 l/s preferably less than about 130 Pa·s@1200 l/s, with less than about 100 Pa·s@1200 l/s being more preferred. LCR viscosity was measured using Laboratory Capillary Rheometer according to ASTM D 3835-02 including that the viscosity is measured using a Dynisco Capillary rheometer at 30:1 L/D (length/diameter) ratio, a shear rate of 1200 l/s and a temperature of 204° C. The entrance angle of the laboratory capillary rheometer is 180°, and the barrel diameter is 9.55 mm. The heat soak time is 6 minutes.

The TPV of the present invention also preferably has an oil swell after 24 hrs at 121° C. of less than about 350%, preferably less than about 250%, with less than about 100% being more preferred. Oil swell (oil gain) was determined after soaking a die-cut sample from compression molded plaque in IRM No. 3 fluid for 24 hours at 125° C. according to ASTM D 471.

The TPV of the present invention preferably has a compression set (22 hr@70° C.), determined according to ISO 815A of less than about 70%, preferably less than about 40%, with less than about 30% being more preferred.

The average size of the discrete portions of the discontinuous phase dispersed with in the continuous phase is preferably less than about 5 micrometers, more preferably less than about 2 micrometers, with less than about 1 micrometer being particularly preferred.

Preparation of TPV

The thermoplastic vulcanizates of this disclosure are generally prepared by melt-mixing in any order, the semi-crystalline polyolefin(s) (e.g. polypropylene thermoplastic), the rubber phase comprising the random propylene diene copolymer, and other ingredients (filler, plasticizer, lubricant, stabilizer, etc.) in a mixer heated to above the melting temperature of the polypropylene thermoplastic. The optional fillers, plasticizers, additives etc., can be added at this stage or later. After sufficient molten-state mixing to form a well mixed blend, vulcanizing agents (also known as curatives or crosslinkers) are generally added.

In some embodiments it is preferred to add the vulcanizing agent in solution with a liquid, for example rubber processing oil, or in a masterbatch which is compatible with the other components. It is convenient to follow the progress of vulcanization by monitoring mixing torque or mixing energy requirements during mixing. The mixing torque or mixing energy curve generally goes through a maximum after which mixing can be continued somewhat longer to improve the fabricability of the blend. If desired, one can add some of the ingredients after the dynamic vulcanization is complete.

After discharge from the mixer, the blend containing vulcanized rubber and the thermoplastic can be milled, chopped, extruded, pelletized, injection-molded, or processed by any other desirable technique. It is usually desirable to allow the fillers and a portion of any plasticizer to distribute themselves in the rubber or semi-crystalline polypropylene phase before the rubber phase or phases are crosslinked. Crosslinking (vulcanization) of the rubber can occur in a few minutes or less depending on the mix temperature, shear rate, and activators present for the curative. Suitable curing temperatures include from about 120° C. or 150° C. to about 250° C., more preferred temperatures are from about 150° C. or 170° C. to about 225° C. or 250° C. The mixing equipment can include Banbury type mixers, Brabender type mixers, multiroll mills and other mixing extruders.

Thermoplastic vulcanizate compositions of the invention are useful for making a variety of articles such as tires, hoses, belts, gaskets, moldings and molded parts. Accordingly, in an embodiment, the present invention comprises an article comprising the thermoplastic vulcanizate of the present invention. The present invention is particularly useful for making articles by extrusion, injection molding, blow molding, and/or compression molding techniques. They also are useful for modifying thermoplastic resins and in particular polyolefin resins. The compositions can be blended with thermoplastic resins using conventional mixing making a rubber modified thermoplastic resin. The properties of the modified thermoplastic resin depend upon the amount of thermoplastic vulcanizate composition blended. In another embodiment, a masterbatch may comprise the thermoplastic vulcanizate of the present invention.

In an embodiment, the thermoplastic vulcanizate composition of the present invention is preferably produced wherein the discontinuous phase is dynamically vulcanized in the presence of the continuous phase to produce the inventive thermoplastic vulcanizate composition.

Accordingly, a method to prepare the thermoplastic vulcanizate composition of the present invention may comprise the steps of:

melt mixing the discontinuous phase, the continuous thermoplastic polyolefin phase, and optionally one or more fillers, plasticizers, or additives to produce a mixed blend; and

mixing the mixed blend with a vulcanizing agent at a curing temperature, to produce the inventive thermoplastic vulcanizate composition.

In an embodiment, the vulcanizing agent may be dissolved or dispersed in a liquid prior to being added to the mixed blend. In a preferred embodiment, the discontinuous phase, the continuous thermoplastic polyolefin phase, optionally one or more fillers, plasticizers, or additives and the vulcanizing agent are mixed in a single step to produce the thermoplastic vulcanizate composition. The curing temperature is preferably about 120° C. to about 250° C.

### EXAMPLES

Physical properties reported below were determined according to the following tests and procedures:

Shore hardness was determined according to ISO868 at 23° C. using a Durometer.

Stress-strain properties such as ultimate tensile strength, ultimate elongation, and 100% modulus were measured on 2 mm thick compression molded plaques at 23° C. by using an Instron testing machine according to ISO 527.

Compression set test was measured according to ISO 815A.

Tension set was measured according to ISO 2285.

Oil swell (oil gain) was determined after soaking a die-cut sample from compression molded plaque in IRM No. 3 fluid for 24 hours at 125° C. according to ASTM D 471.

LCR viscosity was measured using Laboratory Capillary Rheometer according to ASTM D 3835-02 including that the viscosity is measured using a Dynisco Capillary rheometer at 30:1 L/D (length/diameter) ratio, a shear rate of 1200 l/s and a temperature of 204° C. The entrance angle of the laboratory capillary rheometer is 180°, and the barrel diameter is 9.55 mm. The heat soak time is 6 minutes.

Illustrative non-limiting examples of suitable propylene-based elastomers, as well as the methods for preparing them, include the “FPC” disclosed in pending U.S. Provisional Patent Application No. 60/519,975; the “isotactic propylene copolymer” disclosed in U.S. Patent Application Publication No. 2003/0204017; the “propylene ethylene copolymers” disclosed in U.S. Pat. No. 6,525,157; and the “propylene ethylene copolymers” disclosed in PCT Publication No. WO02/083754, the disclosures of which are fully incorporated herein by reference.

Separate from, or in combination with the foregoing, the crystallinity of the propylene-based elastomer can be reduced also by stereo-irregular incorporation of the propylene-derived units, which can be influenced by, for example, the choice of catalyst and polymerization temperature.

The propylene-based elastomers of the present invention are not limited by any particular polymerization method of preparation, and the polymerization processes described herein are not limited by any particular type of reaction vessel.

In a particular embodiment, the catalyst system used to produce the propylene-based elastomer includes one or more transition metal compounds and one or more activators. When alumoxane or aluminum alkyl activators are used, the combined pre-catalyst-to-activator molar ratio is generally from 1:5000 to 10:1. When ionizing activators are used, the combined pre-catalyst-to-activator molar ratio is generally from 10:1 to 1:10. Multiple activators may be used, including using mixtures of alumoxanes or aluminum alkyls with ionizing activators.

In another particular embodiment, the catalyst system includes a bis(cyclopentadienyl) metal compound and either (1) a non-coordinating compatible anion activator, or (2) an alumoxane activator. Non-limiting examples of catalyst systems which can be used are described in U.S. Pat. Nos. 5,198,401 and 5,391,629, which are hereby incorporated herein by reference.

In another embodiment, the propylene-based elastomer is made in the presence of an activating cocatalyst which is a precursor ionic compound comprising a halogenated tetra-aryl-substituted Group 13 anion wherein each aryl substituent contains at least two cyclic aromatic rings. In a particular aspect of this embodiment, the propylene-based elastomer contains greater than 0.2 parts per million, or greater than 0.5 parts per million, or greater than 1 part per million, or greater than 5 parts per million of the residues of the activating cocatalyst.

In another particular embodiment, the catalyst system used to produce the propylene-based elastomer includes a Hf-containing metallocene catalyst, such as but not limited to dimethyl silyl bis(indenyl) hafnium dimethyl, and a non-coordinating anion activator, such as but not limited to dimethyl anilinium tetrakis(heptafluoronaphthyl) borate.

In yet another particular embodiment, the propylene-based elastomer is produced using any of the catalyst systems and polymerization methods disclosed in U.S. Patent Application Publication 2004/0024146, the disclosure of which is hereby incorporated herein by reference.

In yet another particular embodiment, the propylene-based elastomer is produced using a catalyst system such as one of the nonmetallocene, metal-centered, heteroaryl ligand catalyst systems described in U.S. Patent Application Publication 2003/0204017, the disclosure of which is hereby incorporated herein by reference.

Further general process condition information suitable for use in preparing the propylene-based elastomer can be found in disclosures including, but not limited to U.S. Pat. No. 5,001,205 and PCT publications WO96/33227 and WO97/22639. Further information on gas phase polymerization processes can be found in disclosures including, but not limited to U.S. Pat. Nos. 4,543,399; 4,588,790; 5,028,670; 5,317,036; 5,352,749; 5,405,922; 5,436,304; 5,453,471; 5,462,999; 5,616,661; 5,627,242; 5,665,818; 5,668,228; and 5,677,375, and European publications EP-A-0 794 200; EP-A-0 802 202; and EP-B-634 421. Information relating to methods of introducing liquid catalyst systems into fluidized bed polymerizations into a particle lean zone can be found in disclosures including, but not limited to U.S. Pat. No. 5,693,727. Further information on slurry polymerization processes can be found in disclosures including, but not limited to U.S. Pat. Nos. 3,248,179 and 4,613,484. PCT publication WO 96/08520 and U.S. Pat. No. 5,712,352 are non-limiting examples of disclosures which describe a polymerization process operated in the absence of or essentially free of any scavengers.

Listing of Components

| Component | Description | Available from |
|---|---|---|
| Vistamaxx ™ 1000 | Random propylene- | ExxonMobil |
| | ethylene | |
| | copolymer | |
| Vistalon ™ 2504 | EPDM Rubber | ExxonMobil Chemical, |
| (V2504) | | |
| Vistalon ™ 3666 | EPDM Rubber | Exxonmobil Chemical, |
| (V3666) | | |
| Kadox 911 | Zinc Oxide | Zinc Corporation of |
| | | America |
| Stannous Chloride | Stannous | Mason Corp., IN |
| | Chloride | |
| Resin SP-1045 | Phenolic Resin | Schnectady, NY |
| Exxon PP 5341 | Isotactic poly | ExxonMobil |
| | propylene | |
| Sunpar 150M | Paraffinic | Sunoco, Inc., PA |
| | oil | |

The random propylene diene copolymers (RPD CoP) prepared for evaluation are listed in Table 1 along with comparative EPDM rubber components.

TABLE 1

| | | | | | Mooney |
|---|---|---|---|---|---|
| | | | | Heat of | Viscosity |
| | C₂ | ENB | MFR | Fusion | ML1 + 4 @ |
| Material | wt % | wt % | (230°) | J/g | 125 C. |
| RPD CoP-1 | 15.2 | 2.1 | 16.6 | 9.0 | 4.4 |
| RPD CoP-2 | 13.8 | 2.1 | 15.7 | 9.0 | |
| RPD CoP-3 | 13.4 | 2.0 | 3.8 | 20.4 | 17.8 |
| RPD CoP-4 | 10.1 | 2.2 | 16.3 | 40.2 | |
| RPD CoP-5 | 8.0 | 2.1 | 20.7 | 46.3 | |
| RPD CoP-6 | 12.0 | 4.1 | 17.6 | 22 | |
| RPD CoP-7 | 11.8 | 3.9 | 1.9 | | 18.7 |
| Comparative | 16 | 0 | 3 | 6.4 | 22 |
| Vistamaxx ™ 1000 | | | | | |
| Vistalon ™ 2504 | 57.5 | 4.7 | | | 25 |
| Vistalon ™3666 | 64 | | | | 75 (with 75 |
| | | | | | phr oil) |

The six TPV samples listed in Table 2 were prepared using RDP CoP-1, 2, and 6 above in comparison to a relatively low viscosity conventional EPDM rubber (Vistalon™2504)

TABLE 2
Random Propylene Diene Copolymers vs. EPDM Rubber

| | Sample | Sample | Sample | Comparative | Comparative | Comparative |
|---|---|---|---|---|---|---|
| Wt % Material | 1 | 2 | 3 | Sample 4 | Sample 5 | Sample 6 |
| V2504 | | | | 68.1 | 50.8 | 36.1 |
| RPD CoP-1 | 36.1 | | | | | |
| RPD CoP-2 | | 36.1 | | | | |
| RPD CoP-6 | | | 36.1 | | | |
| Kadox 911 (Zinc Oxide) | 0.7 | 0.7 | 0.7 | 1.4 | 1.0 | 0.7 |
| Stannous Chloride | 0.5 | 0.5 | 0.5 | 0.9 | 0.6 | 0.5 |
| Resin SP-1045 | 1.3 | 1.3 | 1.3 | 2.4 | 1.8 | 1.3 |
| Exxon PP 5341 | 14.5 | 14.5 | 14.5 | 27.3 | 20.3 | 14.5 |
| Sunpar 150M Oil #1 | 28.9 | 28.9 | 28.9 | | 12.7 | 28.9 |
| Sunpar 150M Oil #2 | 18.1 | 18.1 | 18.1 | | 12.7 | 18.1 |

Physical Properties

| | | | | | | |
|---|---|---|---|---|---|---|
| Hardness (Shore A) | 53 | 61 | 63 | 81 | 69 | 40 |
| UTS (psi) | 610 | 827 | 790 | 990 | 670 | 174 |
| Elongation (%) | 394 | 445 | 423 | 191 | 234 | 216 |
| 100% Modulus (psi) | 277 | 372 | 334 | 747 | 426 | 143 |
| Tension Set (%) | 17 | 15 | 16 | 15 | 12 | 23 |
| LCR | 76.5 | 74.6 | 77.9 | 427.8 | 200.4 | 77.9 |
| Oil Swell | 256 | 237 | 249 | 245 | 231 | 234 |
| 24 Hr @ 121° C. (%) | | | | | | |
| Compression set | 46.4 | 45.9 | 42.5 | 42.9 | 45.6 | 65.5 |
| 22 hrs @ 70° C. (%) | | | | | | |

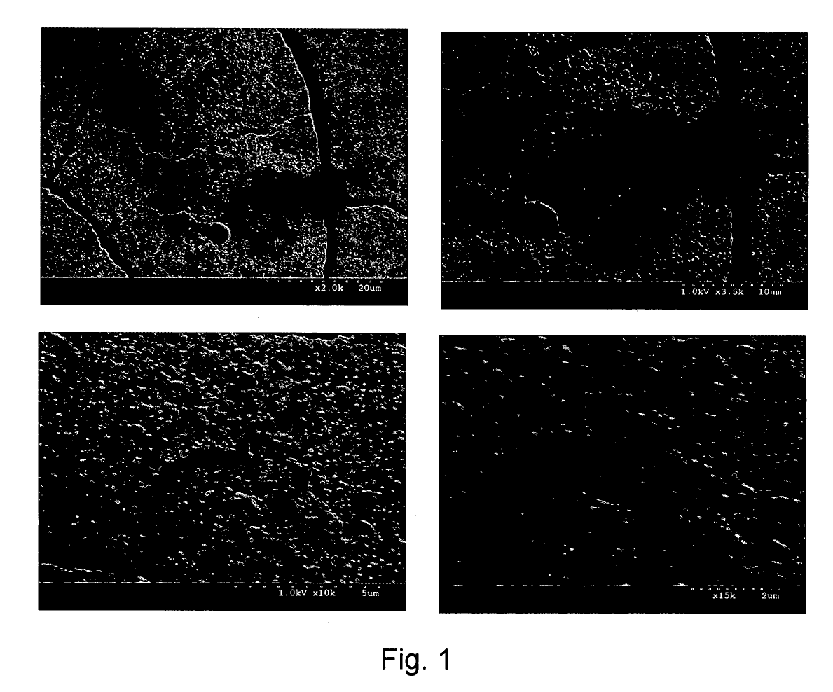

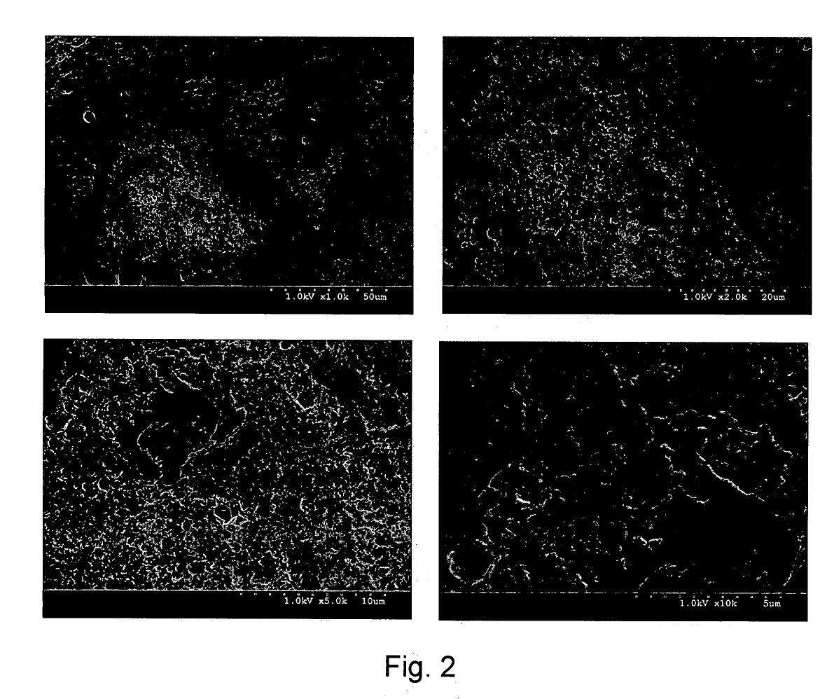

FIG. 1 shows a series of electron micrographs of Sample 2, and FIG. 2 shows a series of electron micrographs of Sample 3.

In the next set of samples listed in Table 3, the amount of random propylene diene copolymer was varied in the TPV.

TABLE 3

| | | | | | | | | | | | Compar- | Compar- |
|---|---|---|---|---|---|---|---|---|---|---|---|---|
| | | | | | | | | | | | ative | ative |
| | Sample | Sample | Sample | Sample | Sample | Sample | Sample | Sample | Sample | Sample | Sample | Sample |
| Wt % Material | 7 | 8 | 9 | 10 | 11 | 12 | 13 | 14 | 15 | 16 | 17 | 18 |
| RPD CoP-1 | 68.1 | 50.8 | | | | | | | | | | |
| RPD CoP-2 | | | 68.1 | 50.8 | | | | | | | | |
| RPD CoP-4 | | | | | 68.1 | 50.8 | | | | | | |
| RPD CoP-5 | | | | | | | 68.1 | 50.8 | | | | |
| RPD CoP-6 | | | | | | | | | 68.1 | 50.8 | | |
| V2504 | | | | | | | | | | | 68.1 | 50.8 |
| Kadox 911 | 1.4 | 1.0 | 1.4 | 1.0 | 1.4 | 1.0 | 1.4 | 1.0 | 1.4 | 1.0 | 1.4 | 1.0 |
| (Zinc Oxide) | | | | | | | | | | | | |
| Stannous | 0.9 | 0.6 | 0.9 | 0.6 | 0.9 | 0.6 | 0.9 | 0.6 | 0.9 | 0.6 | 0.9 | 0.6 |
| Chloride | | | | | | | | | | | | |
| Resin | 2.4 | 1.8 | 2.4 | 1.8 | 2.4 | 1.8 | 2.4 | 1.8 | 2.4 | 1.8 | 2.4 | 1.8 |
| SP-1045 | | | | | | | | | | | | |
| Exxon | 27.3 | 20.3 | 27.3 | 20.3 | 27.3 | 20.3 | 27.3 | 20.3 | 27.3 | 20.3 | 27.3 | 20.3 |
| PP 5341 | | | | | | | | | | | | |
| Sunpar 150M | | 12.7 | | 12.7 | | 12.7 | | 12.7 | | 12.7 | | 12.7 |
| Oil #1 | | | | | | | | | | | | |
| Sunpar 150M | | 12.7 | | 12.7 | | 12.7 | | 12.7 | | 12.7 | | 12.7 |
| Oil #2 | | | | | | | | | | | | |

Physical Properties

| | | | | | | | | | | | | |
|---|---|---|---|---|---|---|---|---|---|---|---|---|
| Hardness | 66 | 69 | 69 | 76 | 49 (Shore D) | 65 | 54 Shore D | 87 | 89 | 75 | 61 | 69 |
| (Shore A) | | | | | | | | | | | | |
| UTS (psi) | 2059 | 1314 | 2041 | 1339 | 2404 | 1986 | 2872 | 2112 | 2453 | 1618 | 990 | 670 |
| Elongation | 231 | 296 | 247 | 262 | 254 | 319 | 281 | 332 | 325 | 355 | 191 | 234 |
| (%) | | | | | | | | | | | | |
| 100% Modulus | 1226 | 546 | 1295 | 681 | 1728 | 984 | 1911 | 1096 | 1150 | 582 | 747 | 426 |
| (psi) | | | | | | | | | | | | |
| Tension Set | 21 | 15 | 27 | 17 | 46 | 25 | 50 | 27 | 29 | 18 | 15 | 12 |
| (%) | | | | | | | | | | | | |
| LCR | | 228 | | 255 | | 233 | | 237 | | 226 | 427.8 | 200.4 |
| Oil Swell | 191 | 173 | 195 | 171 | 189 | 169 | 186 | 179 | 198 | 165 | 245 | 231 |
| 24 Hr @ | | | | | | | | | | | | |
| 121° C. (%) | | | | | | | | | | | | |
| Compression set | 29.0 | 21.6 | 30.8 | 20.7 | 66.8 | 53.0 | 78.0 | 67.9 | 38.9 | 26.9 | 42.9 | 45.6 |
| 22 hrs @ | | | | | | | | | | | | |
| 70° C. (%) | | | | | | | | | | | | |

The following group of samples listed in Table 4 were prepared to evaluate the effect of small amounts of the random propylene diene copolymer when added to a polypropylene base (Vistalon™ 3666) TPV formulation. The effects of product modification on processing and on physical properties were investigated. Formulations comprising a random propylene copolymer (without a diene content, namely Vistamaxx™ 1000) were also included as comparative examples. All the TPV formulations were made in a single step process where the polymer components were compounded together before the curative package was added.

TABLE 4

| | Comparative | Sample | Sample | Sample | Sample | Comparative | Comparative | Comparative | Comparative |
|---|---|---|---|---|---|---|---|---|---|
| Wt % Material | Sample 19 | 20 | 21 | 22 | 23 | Sample 24 | Sample 25 | Sample 26 | Sample 27 |
| V3666 | 63.2 | 62.1 | 61.0 | 59.0 | 57.0 | 62.1 | 61.0 | 59.0 | 57.0 |
| RPD CoP-2 | | 1.8 | 3.5 | 6.7 | 9.8 | | | | |
| Kadox 911 (Zinc Oxide) | 0.7 | 0.7 | 0.7 | 0.7 | 0.7 | 0.7 | 0.7 | 0.7 | 0.7 |
| Stannous Chloride | 0.5 | 0.4 | 0.4 | 0.4 | 0.4 | 0.4 | 0.4 | 0.4 | 0.4 |
| Resin SP-1045 | 1.3 | 1.2 | 1.2 | 1.2 | 1.1 | 1.2 | 1.2 | 1.2 | 1.1 |
| Vistamaxx ™ 1000 | | | | | | 1.8 | 3.5 | 6.7 | 9.8 |
| Exxon PP 5341 | 14.5 | 14.2 | 13.9 | 13.5 | 13.0 | 14.2 | 13.9 | 13.5 | 13.0 |
| Sunpar 150M Oil #1 | 1.8 | 1.8 | 1.7 | 1.7 | 1.6 | 1.8 | 1.7 | 1.7 | 1.6 |
| Sunpar 150M Oil #2 | 18.1 | 17.7 | 17.4 | 16.8 | 16.3 | 17.7 | 17.4 | 16.8 | 16.3 |

Physical Properties

| | | | | | | | | | |
|---|---|---|---|---|---|---|---|---|---|
| Hardness (Shore A) | 57 | 59 | 58 | 58 | 58 | 55 | 56 | 53 | 53 |
| UTS (psi) | 628.8 | 681.3 | 590.5 | 710.4 | 798.4 | 556.8 | 598.2 | 523.6 | 582 |
| Elongation (%) | 260.1 | 267.9 | 288.3 | 342.4 | 357.7 | 230.6 | 262 | 254.5 | 260.4 |
| 100% Modulus (psi) | 330.9 | 345.1 | 312.5 | 323.6 | 346.1 | 319.4 | 334.1 | 270.5 | 289.9 |
| Tension Set (%) | 5 | 5 | 6 | 8 | 8 | 5 | 6 | 6 | 8 |
| LCR | 98.8 | 81.6 | 109.8 | 125.4 | 136.8 | 86.5 | 107 | 109.1 | 111.5 |
| Oil Swell | 92 | 94 | 125 | 133 | 150 | 105 | 116 | 129 | 144 |
| 24 Hr @ 121° C. (%) | | | | | | | | | |
| Compression set | 18.4 | 20.0 | 22.0 | 30.4 | 24.2 | 19.3 | 21.3 | 24.9 | 36.9 |
| 22 hrs @ 70° C. (%) | | | | | | | | | |

In the next set of samples listed in Table 5, a discontinuous phase consisting essentially of a random propylene diene copolymer are compared to samples comprising a random propylene diene copolymer in addition to another rubber component.

TABLE 5

| | Comparative | Sample | Sample | Sample | Sample | Sample | Sample |
|---|---|---|---|---|---|---|---|
| Wt % Material | Sample 26 | 27 | 28 | 29 | 30 | 31 | 32 |
| V3666 | 63 | | | | 62 | 61 | 59 |
| RPD CoP-7 | | 68 | 51 | 45 | 2 | 3 | 7 |
| Kadox 911 (Zinc Oxide) | 1 | 1 | 1 | 1 | 1 | 1 | 1 |
| Stannous Chloride | 0 | 1 | 1 | 1 | 0 | 0 | 0 |
| Resin SP-1045 | 1 | 2 | 2 | 2 | 1 | 1 | 1 |
| Exxon PP 5341 | 14 | 27 | 20 | 18 | 14 | 14 | 13 |
| Sunpar 150M Oil #1 | 2 | | 13 | 11 | 2 | 2 | 2 |
| Sunpar 150M Oil #2 | 18 | | 13 | 23 | 18 | 17 | 17 |

Physical Properties

| | | | | | | | |
|---|---|---|---|---|---|---|---|
| Hardness (Shore A) | 61 | 89 | 77 | 74 | 63 | 61 | 61 |
| UTS (psi) | 579 | 2370 | 1625 | 1310 | 651 | 608 | 703 |
| Elongation (%) | 245 | 298 | 335 | 422 | 228 | 213 | 213 |
| 100% Modulus (psi) | 343 | 1249 | 668 | 543 | 396 | 389 | 443 |
| Tension Set (%) | 5 | 30 | 17 | 19 | 6 | 7 | 7 |
| LCR | 81.3 | Skip high | 217.2 | 156.5 | 99.7 | 101.1 | 124.5 |
| | | pressure | | | | | |
| Oil Swell | 91 | 186 | 171 | 225 | 88 | 91 | 104 |
| 24 Hr @ 121° C. (%) | | | | | | | |
| Compression set | 21.6 | 37.2 | 25.6 | 52.3 | 21.1 | 21.2 | 19.4 |
| 22 hrs @ 70° C. (%) | | | | | | | |

In the following samples listed in Table 6, random propylene diene copolymers having a lower ENB content were compared to TPVs comprising V3666.

TABLE 6

| | Comparative | Sample | Sample | Sample | Sample | Sample | Sample |
|---|---|---|---|---|---|---|---|
| Wt % Material | Sample 33 | 34 | 35 | 36 | 37 | 38 | 39 |
| V3666 | 63 | | | | 62 | 61 | 59 |
| RPD CoP-3 | | 68 | 51 | 45 | 2 | 3 | 7 |
| Kadox 911 (Zinc Oxide) | 1 | 1 | 1 | 1 | 1 | 1 | 1 |
| Stannous Chloride | 0 | 1 | 1 | 1 | 0 | 0 | 0 |
| Resin SP-1045 | 1 | 2 | 2 | 2 | 1 | 1 | 1 |
| Exxon PP 5341 | 14 | 27 | 20 | 18 | 14 | 14 | 13 |
| Sunpar 150M Oil #1 | 2 | | 13 | 11 | 2 | 2 | 2 |
| Sunpar 150M Oil #2 | 18 | | 13 | 23 | 18 | 17 | 17 |

Physical Properties

| | | | | | | | |
|---|---|---|---|---|---|---|---|
| Hardness (Shore A) | 61 | 85 | 78 | 73 | 60 | 59 | 59 |
| UTS (psi) | 568 | 2424 | 1599 | 1172 | 699 | 642 | 644 |
| Elongation (%) | 209 | 172 | 297 | 265 | 271 | 250 | 254 |
| 100% Modulus (psi) | 368 | 1834 | 935 | 642 | 383 | 341 | 348 |
| Tension Set (%) | 6 | 27 | 16 | 14 | 6 | 7 | 7 |
| LCR | 92.4 | 637.4 | 244.8 | 177 | 89 | 92.3 | 105.1 |
| Oil Swell | 86 | 170 | 189 | 169 | 97 | 104 | 118 |
| 24 Hr @ 121° C. (%) | | | | | | | |
| Compression set | 20.5 | 32.2 | 35.4 | 25.3 | 25.5 | 16.9 | 26.1 |
| 22 hrs @ 70° C. (%) | | | | | | | |

Accordingly, embodiments of the present invention include:
1a. A thermoplastic vulcanizate composition comprising a discontinuous phase dispersed within a continuous thermoplastic polyolefin phase,
   wherein the discontinuous phase comprises a random propylene diene copolymer comprising about 68 to 95 mol % propylene, about 5 to about 32 mol % of a C2 or a C4-C20 olefin, and about 0.1 to 10 mol % of a non-conjugated diene, and having a heat of fusion from about 1 to about 70 J/g; and
   wherein the continuous thermoplastic polyolefin phase comprises propylene.
2a. The thermoplastic vulcanizate composition of 1a, wherein the random propylene diene copolymer comprises ethylene, 1-butene, 1-hexene, 1-octene, 4-methyl-1-pentene, 3-methyl-1-pentene, 3,5,5-trimethyl-1-hexene, or a combination thereof.
3a. The thermoplastic vulcanizate composition of any one of 1a or 2a, wherein the random propylene diene copolymer comprises ethylene.
4a. The thermoplastic vulcanizate composition of any one of 1a to 3a, wherein the random propylene diene copolymer comprises 5-ethylidene-2-norbornene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; vinyl norbornene; dicyclopendadiene, or a combination thereof.
5a. The thermoplastic vulcanizate composition of any one of any one of 1a to 4a, wherein the random propylene diene copolymer is produced using a catalyst system comprising a metallocene complex having the general formula:
   (Cp¹R¹ₘ)R³ₙ(Cp²R²ₚ)MX_{q}
   wherein Cp¹ of ligand (Cp¹R¹ₘ) and Cp² of ligand (Cp²R²ₚ) are preferably the same, R¹ and R² are each independently, halogen, hydrocarbyl, halocarbyl, hydrocarbyl-substituted organometalloid or halocarbyl-substituted organometalloid group containing up to 20 carbon atoms;
   m is 1 to 5;
   p is 1 to 5;
   R¹ and R² substituents on adjacent carbon atoms. of the cyclopentadienyl ring associated are joined together to form a ring comprising from 4 to 20 carbon atoms;
   R³ is a bridging group wherein n is the number of atoms in the direct chain between the two ligands and is 1 to 8
   M is a group 4, 5, or 6 transition metal having a valence of from 3 to 6 and in its highest oxidation state,
   each X is a non-cyclopentadienyl ligand selected from the group consisting of hydrocarbyl, oxyhydrocarbyl, halocarbyl, hydrocarbyl-substituted organometalloid, oxyhydrocarbyl-substituted organometalloid or halocarbyl-substituted organometalloid group containing up to 20 carbon atoms; and
   q is equal to the valence of M minus 2.
6a. The thermoplastic vulcanizate composition of any one of 1a to 5a, wherein the random propylene diene copolymer is produced using a catalyst system comprising 1,1′-bis(4-triethylsilylphenyl)methylene-(cyclopentadienyl)(2,7-di-tertiary-butyl-9-fluorenyl)hafnium dimethyl, dimethyl silyl bis(2-methyl-5-phenyl indenyl)ZrMe2, or dimethylsilylbis(indenyl)hafnium dimethyl with dimethylaniliniumtetrakis(pentafluorophenyl)borate as an activator.
7a. The thermoplastic vulcanizate composition of any one of 1a to 6a, wherein the random propylene diene copolymer comprises 5 to 30 mol % ethylene.
8a. The thermoplastic vulcanizate composition of any one of 1a to 7a, wherein the random propylene diene copolymer comprises about 1 to 5 mol % 5-ethylidene-2-norbornene.
9a. The thermoplastic vulcanizate composition of any one of 1a to 8a, wherein the random propylene diene copolymer has a g′ index of 0.95 or greater.
10a. The thermoplastic vulcanizate composition of any one of 1a to 9a, wherein the random propylene diene copolymer has a melt flow rate of greater than 0.2 g/10 min using 2.16 kg at 230° C.
11a. The thermoplastic vulcanizate composition of any one of 1a to 10a, wherein the random propylene diene copolymer has a heat of fusion of less than or equal to about 35 J/g.
12a. The thermoplastic vulcanizate composition of any one of 1a to 11a, comprising about 10 to about 90 parts of the thermoplastic polyolefin phase.
13a. The thermoplastic vulcanizate composition of any one of 1a to 12a, wherein the thermoplastic polyolefin phase comprises isotactic polypropylene.
14a. The thermoplastic vulcanizate composition of any one of 1a to 13a, wherein the thermoplastic polyolefin phase comprises syndiotactic polypropylene.
15a. The thermoplastic vulcanizate composition of any one of 1a to 14a, comprising at least about 20 wt % of the discontinuous phase, based on the total amount of the discontinuous phase and the continuous thermoplastic polyolefin phase present.
16a. The thermoplastic vulcanizate composition of any one of 1a to 15a, comprising at least about 50 wt % of the discontinuous phase, based on the total amount of the discontinuous phase and the continuous thermoplastic polyolefin phase present in the composition.
17a. The thermoplastic vulcanizate composition of any one of 1a to 16a, wherein the discontinuous phase comprises at least about 1 wt % of the random propylene diene copolymer, based on the total amount of the discontinuous phase present in the composition.
18a. The thermoplastic vulcanizate composition of any one of 1a to 17a, wherein the discontinuous phase comprises at least about 10 wt % of the random propylene diene copolymer, based on the total amount of the discontinuous phase present in the composition.
19a. The thermoplastic vulcanizate composition of any one of 1a to 18a, wherein the discontinuous phase consists essentially of the random propylene diene copolymer.
20a. The thermoplastic vulcanizate composition of any one of 1a to 19a, wherein the discontinuous phase comprises one or more rubber compounds selected from the group consisting of butyl rubber, halobutyl rubber, a halogenated copolymer of p-alkylstyrene and an isomonoolefin of 4 to 7 carbon atoms, EPDM rubber, natural rubber, or a combination thereof.
21a. The thermoplastic vulcanizate composition of any one of 1a to 20a, wherein the composition is essentially free of EPDM rubber.
22a. The thermoplastic vulcanizate composition of any one of 1a to 21a, further comprising one or more additives selected from the group consisting of fillers, extender oils, processing oils, lubricants, stabilizers, antioxidants, curatives, or a combination thereof.
23a. The thermoplastic vulcanizate composition of any one of 1a to 22a, wherein the discontinuous phase was dynamically vulcanized in the presence of the continuous phase to produce the thermoplastic vulcanizate composition.
24a. The thermoplastic vulcanizate composition of any one of 1a to 23a, having a Shore A hardness of less than about 80.
25a. The thermoplastic vulcanizate composition of any one of 1a to 24a, having a tensile strength at break of greater than about 0.5 MPa.
26a. The thermoplastic vulcanizate composition of any one of 1a to 25a, having an ultimate elongation of greater than about 50%.
27a. The thermoplastic vulcanizate composition of any one of 1a to 26a, having a tension set of less than about 70%.
28a. The thermoplastic vulcanizate composition of any one of 1a to 27a, having a linear capillary rheometer viscosity of less than about 200 Pa·s at 1200 Hz.
29a. The thermoplastic vulcanizate composition of any one of 1a to 28a, having an oil swell after 24 hours at 121° C. of less than about 350%.
30a. The thermoplastic vulcanizate composition of any one of 1a to 29a, having a compression set determined at 22 hours and 70° C. of less than about 70%.
31a. The thermoplastic vulcanizate composition of any one of 1a to 30a, wherein the average size of the discrete portions of the discontinuous phase dispersed in the continuous phase is less than about 5 micrometers
32a. An article comprising the thermoplastic vulcanizate of any one of 1a to 31a.
33a. The article of 32a, wherein the article is molded, injection molded, blow molded, compression molded, extruded, or a combination thereof.
34a. The article of 32a or 33a, wherein the article is a tubing, tire, a belt, or a gasket.
35a. A thermoplastic vulcanizate composition comprising a discontinuous phase dispersed within a continuous polypropylene phase,
   wherein the discontinuous phase comprises a random propylene diene copolymer comprising about 84 to 92 wt % propylene, about 8 to about 16 wt % of ethylene, and about 2 to 4 wt % of 5-ethylidene-2-norbornene, and having a heat of fusion from about 1 to about 70 J/g.
36a. The thermoplastic vulcanizate composition of 35a, wherein the average size of the discrete portions of the discontinuous phase dispersed in the continuous polypropylene phase is less than about 1 micrometer.
37a. The thermoplastic vulcanizate composition of 35a or 36a, wherein the random propylene diene copolymer has a melt flow rate using 2.16 kg at 230° C. of about 10 to 30 g/10 min.
38a. A thermoplastic vulcanizate composition comprising a discontinuous phase dispersed within a continuous polypropylene phase,
   wherein the discontinuous phase consists essentially of a random propylene diene copolymer comprising about 84 to 92 wt % propylene, about 8 to about 16 wt % of ethylene, and about 2 to 4 wt % of 5-ethylidene-2-norbornene, and having a heat of fusion from about 1 to about 70 J/g.
39a. The thermoplastic vulcanizate composition of 38a, wherein the average size of the discrete portions of the discontinuous phase dispersed in the continuous polypropylene phase is less than about 1 micrometer.
40a. The thermoplastic vulcanizate composition of 38a or 39a, wherein the random propylene diene copolymer has a melt flow rate using 2.16 kg at 230° C. of about 10 to 30 g/10 min.
41a. A thermoplastic vulcanizate composition consisting essentially of a discontinuous phase dispersed within a continuous polypropylene phase,
   wherein the discontinuous phase consists essentially of a random propylene diene copolymer comprising about 84 to 92 wt % propylene, about 8 to about 16 wt % of ethylene, and about 2 to 4 wt % of 5-ethylidene-2-norbornene, and having a heat of fusion from about 1 to about 70 J/g.
42a. The thermoplastic vulcanizate composition of 41a, wherein the average size of the discrete portions of the discontinuous phase dispersed in the continuous polypropylene phase is less than about 1 micrometer.
43a. The thermoplastic vulcanizate composition of 41a or 42a, wherein the random propylene diene copolymer has a melt flow rate using 2.16 kg at 230° C. of about 10 to 30 g/10 min.
44a. A method to prepare the thermoplastic vulcanizate composition of any one of 1a to 43a, comprising the steps of:
   melt mixing the discontinuous phase, the continuous thermoplastic polyolefin phase, and optionally one or more fillers, plasticizers, or additives to produce a mixed blend
   mixing the mixed blend with a vulcanizing agent at a curing temperature, to produce the thermoplastic vulcanizate composition.
45a. The method of 44a, wherein the vulcanizing agent is dissolved or dispersed in a liquid prior to being added to the mixed blend.
46a. The method of 44a or 45a, wherein the discontinuous phase, the continuous thermoplastic polyolefin phase, optionally one or more fillers, plasticizers, or additives and the vulcanizing agent are mixed in a single step to produce the thermoplastic vulcanizate composition.
47a. The method of 44a to 46a, wherein the curing temperature is about 120° C. to about 250° C.

While in accordance with the patent statutes the best mode and preferred embodiment has been set forth, the scope of the invention is not limited thereto, but rather by the scope of the attached claims.

We claim:

1. A thermoplastic vulcanizate composition comprising a discontinuous phase dispersed within a continuous thermoplastic polyolefin phase,
wherein the discontinuous phase comprises a random propylene diene copolymer comprising about 68 to 95 mol % propylene, about 5 to about 32 mol % of a C₂ or a C₄-C₂₀ olefin, and about 0.1 to 10 mol % of a non-conjugated diene, and having a heat of fusion from about 1 to about 70 J/g; and
wherein the continuous thermoplastic polyolefin phase comprises propylene.

2. The thermoplastic vulcanizate composition of claim 1, wherein the random propylene diene copolymer comprises ethylene, 1-butene, 1-hexene, 1-octene, 4-methyl-1-pentene, 3-methyl-1-pentene, 3,5,5-trimethyl-1-hexene, or a combination thereof.

3. The thermoplastic vulcanizate composition of claim 1, wherein the random propylene diene copolymer comprises ethylene.

4. The thermoplastic vulcanizate composition of claim 1, wherein the random propylene diene copolymer comprises 5-ethylidene-2-norbornene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; vinyl norbornene; dicyclopendadiene, or a combination thereof.

5. The thermoplastic vulcanizate composition of claim 1, wherein the random propylene diene copolymer is produced using a catalyst system comprising a metallocene complex having the general formula:
(Cp¹R¹ₘ)R³ₙ(Cp²R²ₚ)MX_{q}
wherein Cp¹ of ligand (Cp¹R¹ₘ) and Cp² of ligand (Cp²R²ₚ) are preferably the same, R¹ and R² are each independently, halogen, hydrocarbyl, halocarbyl, hydrocarbyl-substituted organometalloid or halocarbyl-substituted organometalloid group containing up to 20 carbon atoms;
m is 1 to 5;
p is 1 to 5;
R¹ and R² substituents on adjacent carbon atoms of the cyclopentadienyl ring associated are joined together to form a ring comprising from 4 to 20 carbon atoms;
R³ is a bridging group wherein n is the number of atoms in the direct chain between the two ligands and is 1 to 8
M is a group 4, 5, or 6 transition metal having a valence of from 3 to 6 and in its highest oxidation state,
each X is a non-cyclopentadienyl ligand selected from the group consisting of hydrocarbyl, oxyhydrocarbyl, halocarbyl, hydrocarbyl-substituted organometalloid, oxyhydrocarbyl-substituted organometalloid or halocarbyl-substituted organometalloid group containing up to 20 carbon atoms; and
q is equal to the valence of M minus 2.

6. The thermoplastic vulcanizate composition of claim 1, wherein the random propylene diene copolymer is produced using a catalyst system comprising 1,1′-bis(4-triethylsilylphenyl)methylene-(cyclopentadienyl)(2,7-di-tertiary-butyl-9-fluorenyl)hafnium dimethyl, dimethyl silyl bis(2-methyl-5-phenyl indenyl)ZrMe₂, or dimethylsilylbis(indenyl)hafnium dimethyl with dimethylaniliniumtetrakis (pentafluorophenyl) borate as an activator.

7. The thermoplastic vulcanizate composition of claim 1, wherein the random propylene diene copolymer comprises 5 to 30 mol % ethylene.

8. The thermoplastic vulcanizate composition of claim 1, wherein the random propylene diene copolymer comprises about 1 to 5 mol % 5-ethylidene-2-norbornene.

9. The thermoplastic vulcanizate composition of claim 1, wherein the random propylene diene copolymer has a g′ index of 0.95 or greater.

10. The thermoplastic vulcanizate composition of claim 1, wherein the random propylene diene copolymer has a melt flow rate of greater than 0.2 g/10 min using 2.16 kg at 230° C.

11. The thermoplastic vulcanizate composition of claim 1, wherein the random propylene diene copolymer has a heat of fusion of less than or equal to about 35 J/g.

12. The thermoplastic vulcanizate composition of claim 1, comprising about 10 to about 90 parts of the thermoplastic polyolefin phase.

13. The thermoplastic vulcanizate composition of claim 1, wherein the thermoplastic polyolefin phase comprises isotactic polypropylene.

14. The thermoplastic vulcanizate composition of claim 1, wherein the thermoplastic polyolefin phase comprises syndiotactic polypropylene.

15. The thermoplastic vulcanizate composition of claim 1, comprising at least about 20 wt % of the discontinuous phase, based on the total amount of the discontinuous phase and the continuous thermoplastic polyolefin phase present.

16. The thermoplastic vulcanizate composition of claim 1, comprising at least about 50 wt % of the discontinuous phase, based on the total amount of the discontinuous phase and the continuous thermoplastic polyolefin phase present in the composition.

17. The thermoplastic vulcanizate composition of claim 1, wherein the discontinuous phase comprises at least about 1 wt % of the random propylene diene copolymer, based on the total amount of the discontinuous phase present in the composition.

18. The thermoplastic vulcanizate composition of claim 1, wherein the discontinuous phase comprises at least about 10 wt % of the random propylene diene copolymer, based on the total amount of the discontinuous phase present in the composition.

19. The thermoplastic vulcanizate composition of claim 1, wherein the discontinuous phase consists essentially of the random propylene diene copolymer.

20. The thermoplastic vulcanizate composition of claim 1, wherein the discontinuous phase comprises one or more rubber compounds selected from the group consisting of butyl rubber, halobutyl rubber, a halogenated copolymer of p-alkylstyrene and an isomonoolefin of 4 to 7 carbon atoms, EPDM rubber, natural rubber, or a combination thereof.

21. The thermoplastic vulcanizate composition of claim 1, wherein the composition is essentially free of EPDM rubber.

22. The thermoplastic vulcanizate composition of claim 1, further comprising one or more additives selected from the group consisting of fillers, extender oils, processing oils, lubricants, stabilizers, antioxidants, curatives, or a combination thereof.

23. The thermoplastic vulcanizate composition of claim 1, wherein the discontinuous phase was dynamically vulcanized in the presence of the continuous phase to produce the thermoplastic vulcanizate composition.

24. The thermoplastic vulcanizate composition of claim 1, having a Shore A hardness of less than about 80.

25. The thermoplastic vulcanizate composition of claim 1, having a tensile strength at break of greater than about 0.5 MPa.

26. The thermoplastic vulcanizate composition of claim 1, having an ultimate elongation of greater than about 50%.

27. The thermoplastic vulcanizate composition of claim 1, having a tension set of less than about 70%.

28. The thermoplastic vulcanizate composition of claim 1, having a linear capillary rheometer viscosity of less than about 200 Pa·s at 1200 Hz.

29. The thermoplastic vulcanizate composition of claim 1, having an oil swell after 24 hours at 121° C. of less than about 350%.

30. The thermoplastic vulcanizate composition of claim 1, having a compression set determined at 22 hours and 70° C. of less than about 70%.

31. The thermoplastic vulcanizate composition of claim 1, wherein the average size of the discrete portions of the discontinuous phase dispersed in the continuous phase is less than about 5 micrometers

32. An article comprising the thermoplastic vulcanizate of claim 1.

33. The article of claim 32, wherein the article is molded, injection molded, blow molded, compression molded, extruded, or a combination thereof.

34. The article of claim 32, wherein the article is a tubing, tire, a belt, or a gasket.

35. A thermoplastic vulcanizate composition comprising a discontinuous phase dispersed within a continuous polypropylene phase,
wherein the discontinuous phase comprises a random propylene diene copolymer comprising about 84 to 92 wt % propylene, about 8 to about 16 wt % of ethylene, and about 2 to 4 wt % of 5-ethylidene-2-norbornene, and having a heat of fusion from about 1 to about 70 J/g.

36. The thermoplastic vulcanizate composition of claim 35, wherein the average size of the discrete portions of the discontinuous phase dispersed in the continuous polypropylene phase is less than about 1 micrometer.

37. The thermoplastic vulcanizate composition of claim 35, wherein the random propylene diene copolymer has a melt flow rate using 2.16 kg at 230° C. of about 10 to 30 g/10 min.

38. A thermoplastic vulcanizate composition comprising a discontinuous phase dispersed within a continuous polypropylene phase,
wherein the discontinuous phase consists essentially of a random propylene diene copolymer comprising about 84 to 92 wt % propylene, about 8 to about 16 wt % of ethylene, and about 2 to 4 wt % of 5-ethylidene-2-norbornene, and having a heat of fusion from about 1 to about 70 J/g.

39. The thermoplastic vulcanizate composition of claim 38, wherein the average size of the discrete portions of the discontinuous phase dispersed in the continuous polypropylene phase is less than about 1 micrometer.

40. The thermoplastic vulcanizate composition of claim 38, wherein the random propylene diene copolymer has a melt flow rate using 2.16 kg at 230° C. of about 10 to 30 g/10 min.

41. A thermoplastic vulcanizate composition consisting essentially of a discontinuous phase dispersed within a continuous polypropylene phase,
wherein the discontinuous phase consists essentially of a random propylene diene copolymer comprising about 84 to 92 wt % propylene, about 8 to about 16 wt % of ethylene, and about 2 to 4 wt % of 5-ethylidene-2-norbornene, and having a heat of fusion from about 1 to about 70 J/g.

42. The thermoplastic vulcanizate composition of claim 41, wherein the average size of the discrete portions of the discontinuous phase dispersed in the continuous polypropylene phase is less than about 1 micrometer.

43. The thermoplastic vulcanizate composition of claim 41, wherein the random propylene diene copolymer has a melt flow rate using 2.16 kg at 230° C. of about 10 to 30 g/10 min.

44. A method to prepare the thermoplastic vulcanizate composition of claim 1, comprising the steps of:
melt mixing the discontinuous phase, the continuous thermoplastic polyolefin phase, and optionally one or more fillers, plasticizers, or additives to produce a mixed blend
mixing the mixed blend with a vulcanizing agent at a curing temperature, to produce the thermoplastic vulcanizate composition.

45. The method of claim 44, wherein the vulcanizing agent is dissolved or dispersed in a liquid prior to being added to the mixed blend.

46. The method of claim 44, wherein the discontinuous phase, the continuous thermoplastic polyolefin phase, optionally one or more fillers, plasticizers, or additives and the vulcanizing agent are mixed in a single step to produce the thermoplastic vulcanizate composition.

47. The method of claim 44, wherein the curing temperature is about 120° C. to about 250° C.
